(19) United States
(12) Patent Application Publication
(10) Pub. No.: US 2006/0286356 A1
(43) Pub. Date: Dec. 21, 2006

(54) Web materials with active agent

(76) Inventors: Toby R. Thomas, Pleasant Prairie, WI (US); Nathan A. Kolovich, Round Lake, IL (US); Craig E. Cappel, Lake Villa, IL (US)

Correspondence Address: BAKER BOTTS, LLP, 30 ROCKEFELLER PLAZA, NEW YORK, NY, 10112-4498, US

(21) Appl. No.: 11/418,891

(22) Filed: May 5, 2006

Related U.S. Application Data
(63) Continuation-in-part of application No. 11/055,575, filed on Feb. 10, 2005.
Application No. 11/055,575 is a continuation-in-part of application No. 10/375,188, filed on Feb. 26, 2003.
(63) Continuation-in-part of application No. 11/055,574, filed on Feb. 10, 2005.
Application No. 11/055,574 is a continuation-in-part of application No. 10/375,188, filed on Feb. 26, 2003.
(60) Provisional application No. 60/359,874, filed on Feb. 27, 2002.
(60) Provisional application No. 60/543,344, filed on Feb. 10, 2004.
(60) Provisional application No. 60/543,345, filed on Feb. 10, 2004.
(60) Provisional application No. 60/359,874, filed on Feb. 27, 2002.
(60) Provisional application No. 60/543,344, filed on Feb. 10, 2004.
(60) Provisional application No. 60/543,345, filed on Feb. 10, 2004.

(51) Int. Cl. B44C 1/17

(52) U.S. Cl. 428/195.1

(57) ABSTRACT

A web for use as wrap material, lidding material or in packages with active agents. Generally, each disclosed structure includes at least a first material layer made of a barrier material; and an active agent carried by the first material layer. Webs in accordance with the invention can further include a second material layer disposed adjacent the first material layer, wherein the second material layer has a predetermined material property, such as permeability, cling and/or sealing characteristics.

### REFERENCE TO RELATED APPLICATIONS

The present application is a continuation-in-part of U.S. patent application Ser. Nos. 11/055,575 and 11/055,574, each of which filed Feb. 10, 2005, is currently pending and is a continuation-in-part application of U.S. patent application Ser. No. 10/375,188 filed on Feb. 26, 2003, which is currently pending and claims the benefit under 35 U.S.C. § 119(e) of U.S. Patent Application No. 60/359,874 filed on Feb. 27, 2002. U.S. patent application Ser. Nos. 11/055,575 and 11/055,574 also each claim the benefit under 35 U.S.C. § 119(e) of both U.S. Patent Application No. 60/543,344 and U.S. Patent Application No. 60/543,345 filed on Feb. 10, 2004, to which the present application also claims priority.

Each of the foregoing applications is expressly incorporated by reference herein in its entirety.

### FIELD OF THE INVENTION

The present invention relates to a web material, and more particularly to a web material for use in forming packages, and to structures and methods for releasing active agents in such packages. More specifically, the present invention relates to active agents, such as freshness-extension agents, odor management agents, and other functional agents, and structures and methods for releasing such active agents to extend the freshness of perishable products and manage or control the odor related to such products disposed within such packages, for example.

### BACKGROUND OF THE INVENTION

The use of packages for a number of household and industrial purposes has gained wide acceptance. For example, wraps, bags and containers are commonly used by commercial entities and consumers to store perishable products and items. Also for example, bags or liners are commonly used in industrial settings and households to collect garbage or waste.

Reclosable packages, such as food containers with fitted or hinged lids, and bags with pinch-to-close or slider fasteners, are a great convenience to suppliers and consumers of pre-packaged perishables, especially for products such as luncheon meats and cheeses where, typically, only a portion of the product is used at any given time. Additionally, perishables are often packaged in wrap materials and in containers, such as trays, on which a film overwrap or lid material is applied to seal the container. Such containers are often used, for example, for prepackaged foods, such as meats and cheeses, or for storage by a consumer. Although sufficient for its intended purpose, it is desirable to provide a web material for such packages having qualities to extend the shelf life of the product contained therein.

Packages such as thermoplastic bags or liners are also commonly used as waste or garbage bags. Generally, such bags are constructed from a structure having two layers of thermoplastic web or film, joined along three sides and having a mouth formed along the fourth side. A need also exists to provide efficient, affordable and effective odor control for waste or garbage bags.

Web materials used to form the foregoing and other packages typically consist of extruded polymers. As used herein, the term “web” includes a variety of thin material structures, such as films, sheets and the like. Such web materials can be used in stock form for the manufacture of wrap or lidding materials. Alternatively, the web materials can be used in forming processes, such as thermoforming processes to form contoured containers, or heat sealing processes to form flexible containers, such as bags. In the case of wrap materials, a cling material or cling layer is typically desirable. In the case of lidding materials, materials that facilitate heat sealing or are otherwise capable of being adhered to another material, for example by way of an adhesive, are typically desirable.

### SUMMARY OF THE INVENTION

Packages and materials for forming such packages having active agents are disclosed herein.

In accordance with the invention, a web material is provided having a first material layer made of a barrier material and an active agent carried by the first material layer. As used herein, the term “web” generally includes relatively thin material structures, such as a film, a sheet, or the like. In some aspects, as used herein, a “web” can be provided as a continuous sheet of material manufactured or undergoing manufacture, or a portion thereof, such as in the form of a panel or sheet. A web can range from between 0.2 mil and 100 mil in thickness. For use in flexible packages, such as bags, the thickness is preferably between 0.7 mil and 6 mil. For use in more rigid containers, the web thickness is preferably between 8 mil and 100 mil. For use as a wrap material, the thickness is preferably between 0.5 mil and 1.5 mil, and for use as a lidding material, the thickness is preferably between 1 mil and 15 mil. As used herein, 1 mil is equal to 1/1000 inch.

Preferably, the barrier material of the first layer is capable of inhibiting the transfer of water and/or active agent therethrough. Embodied as such, the barrier material is preferably capable of inhibiting transfer of solid, liquid and gas forms of water and active agent. Generally, barrier materials that demonstrate resistance to oxygen diffusion also demonstrate resistance to the diffusion of active agent vapor therethrough.

The active agent can be disposed on the first material layer, such as in a coating applied thereto, or can be impregnated or otherwise incorporated into the first material layer. If the active agent is disposed in the form of a coating on the first material layer, the coating can be formed or applied by a spray, by dipping the first material layer into active agent, through static adhesion, printing, co-extrusion, electroless deposition, casting, vapor deposition, fusion, and/or embedding processes. Printing can include any suitable method, such as with printing plates, roller, brush, or ink jet.

In accordance with a further aspect of the invention, the active agent can be disposed in the form of a stripe or pattern on the first material layer. The stripe can be applied as coating, co-extruded with the first material layer, or applied as a separate layer. The pattern can include a logo, stripes, cross-hatch pattern, dots or the like. The pattern can extend essentially across an entire surface of the first material layer, or can be applied only to a predetermined area, which itself can be in the form of a stripe or band.

If the active agent is incorporated in the web material, any of a variety of suitable techniques can be used. For example, the active agent can be disposed in microcapsules, or through co-extrusion with the barrier material of the first material layer, for example.

The active agent can be selected, for example, from freshness-extension agents, antimicrobial agents, odor management agents, color indicators, spoilage indicators, fragrants, and combinations thereof.

Web materials, in accordance with the invention, can include a second material layer having a predetermined material property. Such material properties can include cling characteristics and/or sealing characteristics. Such characteristics can be imparted by way of forming the second layer of the web material from one or more suitable materials.

Additionally or alternatively, the second material layer can be permeable to the active agent and/or water, and can be hydrophilic. In this manner, the active agent can be disposed in an intermediate layer between the first material layer and the second material layer. Release and/or production of active agent can be effected by the introduction of water.

Alternatively, the second material layer can be made of a barrier material, and can be removable from the first material layer. Also, in accordance with the invention, the web material can be disposed in a roll.

The web material of the invention can form a lidding material or a wrap material, based on the material provided for the first layer. Alternatively, the web material can be formed into a package or at least a body panel thereof. For example, certain packages include a pair of opposing body panels joined together along a pair of opposing sides and a bottom bridging the sides, a reclosable fastener extending along a mouth formed opposite the bottom, and at least one active agent. Certain other packages disclosed herein are rigid or semi-rigid molded containers where a film lid or over wrap has been applied thereto, while in other embodiments, packages are wrap materials, such as food wrap, that are used to cover perishable items. In alternative embodiments, such wrap materials can be used to protect and preserve agricultural produce, such as in the form of wraps to apply to pallets of recently harvested produce, or the like.

In accordance with another aspect of the invention, a bag is provided that includes a pair of opposing body panels, wherein at least one of the body panels is formed of a web. The pair of opposing body panels are joined together along a pair of opposing sides and a bottom bridging the sides to define a compartment between the opposing body panels. The web, from which at least one of the body panels is formed, includes a first material layer made of a barrier material, and an active agent carried by the first material layer in communication with the compartment. A mouth can be defined between the pair of panels opposite the bottom, and active agent can be disposed in a stripe proximate the mouth. Further, any of the optional features set forth above can be incorporated into this aspect of the invention.

These and other features of the disclosed packages of the present invention can be more fully understood by referring to the following detailed description and accompanying drawings. The drawings are not drawn to scale, but show only relative dimensions.

### BRIEF DESCRIPTION OF THE DRAWINGS

FIG. 1 is a sectional view of a mouth portion of a reclosable package or bag with the opposing body panels attached to respective fin portions according to one embodiment of the present invention;

FIG. 2 is a perspective view of the reclosable package incorporating the mouth portion depicted in FIG. 1 in which the reclosable fastener or zipper has a slider mechanism being opened and the one-time breakable element being partially opened according to another embodiment;

FIG. 3a is a partial cross-sectional view of one side of a reclosable package or bag comprising a polymeric structure with one layer according to one embodiment of the present invention;

FIG. 3b is a partial cross-sectional view of one side of a reclosable package or bag comprising a polymeric structure with two layers according to one embodiment of the present invention;

FIG. 3c is a partial cross-sectional view of one side of a reclosable package or bag comprising a polymeric structure with three layers according to one embodiment of the present invention;

FIG. 3d is a partial cross-sectional view of one side of a reclosable package or bag comprising a polymeric structure with two layers according to another embodiment of the present invention;

FIG. 4 is a partial cross-sectional view of one side of a reclosable package or bag according to another embodiment of the present invention;

FIG. 5 is a partial cross-sectional view of one side of a reclosable package or bag according to a further embodiment of the present invention;

FIG. 6 is a partial cross-sectional view of one side of a reclosable package or bag according to yet another embodiment of the present invention;

FIG. 7 is a partial cross-sectional view of one side of a reclosable package or bag according to yet a further embodiment of the present invention;

FIG. 8 is a partial cross-sectional view of one side of a reclosable package or bag according to another embodiment of the present invention;

FIG. 9a is a partial cross-sectional view of one side of a reclosable package or bag that includes a polymeric structure with four layers according to one embodiment of the present invention;

FIG. 9b is a partial cross-sectional view of one side of a reclosable package or bag that includes a polymeric structure with six layers according to one embodiment of the present invention;

FIG. 10a is a partial cross-section view of two sides of a reclosable package or bag that includes two polymeric structures that each comprise two layers according to one embodiment of the present invention;

FIG. 10b is a partial cross-section view of two sides of a reclosable package or bag that includes two polymeric structures that each comprise two layers according to another embodiment of the present invention;

FIG. 10c is a partial cross-section view of two sides of a reclosable package or bag that includes two polymeric structures that each comprise three layers according to one embodiment of the present invention;

FIG. 11a is a partial cross-section view of two sides of a reclosable package or bag with a polymeric structure disposed therebetween, in which the polymeric structure includes a one-time breakable element.

FIG. 11b is a partial cross-section view showing the reclosable package or bag of FIG. 11a after breakage of the one-time breakable element;

FIG. 12a is a partial cross-section view of two sides of a reclosable package or bag, in which one side includes a polymeric structure that comprises two layers, and in which the polymeric structure is connected to the other side by a removable element;

FIG. 12b is a partial cross-section view showing the reclosable package or bag of FIG. 12a after removal of the removable element;

FIG. 13 is an isometric view of one embodiment of a web material web material in accordance with the invention, including a two-layer structure;

FIG. 14 is an isometric view of another embodiment of a web material in accordance with the invention, including a three-layer structure;

FIGS. 15 and 16 are isometric and end views, respectively, of another embodiment of a web material in accordance with the invention, including a stripe embedded between first and second layers of the web material;

FIG. 17 is an isometric view of another embodiment of a web material in accordance with the invention, including active agent applied in a pattern;

FIG. 18 is an isometric view of another embodiment of a web material in accordance with the invention, including active agent incorporated into a portion of the web material;

FIG. 19 is an isometric view of another embodiment of a web material in accordance with the invention, including active agent applied as a stripe to a base layer of the web material;

FIG. 20 is an isometric view of another embodiment of a web material in accordance with the invention, including active agent applied in a pattern;

FIG. 21 is an isometric view of another embodiment of a web material in accordance with the invention, wherein the web material is being formed into a reclosable bag;

FIG. 22 is an isometric view of another embodiment of a web material in accordance with the invention, wherein the web material with a stripe of active agent has been formed into a reclosable bag;

FIG. 23 is an isometric view of another embodiment of a web material in accordance with the invention, wherein the web material includes a plurality of stripes of active agent;

FIG. 24 is an isometric view of another embodiment of a web material in accordance with the invention, wherein the web material includes a central stripe of active agent;

FIG. 25 is an end view of a reclosable bag formed by the web material of FIG. 24; and

FIG. 26 is an isometric view of another embodiment of a web material in accordance with the invention, wherein the web material having active agent is a lidding material.

### DETAILED DESCRIPTION

The present invention relates to packages, packaging materials, materials for forming such packages and other related web materials having an active agent incorporated therein or carried thereon. As such, the invention has applications for various flexible and rigid containers and packages, such as reclosable plastic bags, waste bags and liners, rigid trash containers, air-tight storage containers, food containers, as well as wraps and foils commonly used for packaging, covering or sealing perishable items.

In accordance with one aspect of the invention, a web material is provided including a first layer of barrier material with an active agent carried thereon. In one embodiment, the barrier layer defines at least a portion of a body panel of a package. The active agent can be carried on the barrier layer in the form of a pouch, patch, tape or the like, or can otherwise be printed, coated, adhered to or incorporated, impregnated or disposed on the first layer. Various embodiments will be described for the purpose of illustration and not limitation.

As used herein, the term “package” can be understood to include any kind of package or container, such as flexible plastic bags and rigid containers, as well as foils, wraps or lidding materials commonly used to package or store perishable items.

As used herein, the term “active agent” can be understood to include any agent, ingredient, or composition that provides an enhancing or beneficial effect within a package or container. An active agent can include a “freshness-extension” agent for extending the freshness or shelf life of food products or other perishables stored in a package, an “odor management” agent for masking, neutralizing and/or reducing odors from the package, or another functional agent. For example, an active agent can include an atmosphere modifier, e.g., a drying agent, a water absorbing agent, or a gas releasing agent; an enhancer, e.g., a flavor enhancer, an odor enhancer, or an agent that enhances any other function, such as water absorption, insulation, or microwave cooking; an inhibitor which inhibits or deters a certain condition, e.g., a spoilage inhibitor, a fungus inhibitor, a soil inhibitor, a flame inhibitor, a UV inhibitor, a freezer bum inhibitor, or an anti-static agent; or an indicator, e.g., an indicator of food ripeness or spoilage, or of contamination, temperature, moisture, modified atmosphere, or the presence of particular gas or a compound in the atmosphere, or the passage of time, e.g. timed release; or otherwise used or used in conjunction with such an indicator.

Each of the active agents of the present invention can be used in combination with the web material and the packages formed with such web materials, as described below. For example, each freshness-extension agent of the present invention can be used to inhibit spoilage of food products or other perishables in the packages or packaging materials, and each odor management agent of the present invention can be used to reduce, neutralize, and/or mask odors from the package. Each of the active agents of the present invention can be carried by or otherwise disposed on the web material so as to be in communication with the environment of the package, e.g., disposed in the form of a coating, patch, pouch, or tape that is attached to a component of the package; extruded with a component of the package; sprayed, brushed, coated, laminated, or stamped onto a component of the package; impregnated into a component of the package; and/or distributed in the material of a component of the package, such as in the form of microcapsules. The active agents can also be carried by or disposed on a web material for use as, or as part of packages by printing, which can be achieved by printing plates, rollers, brushes, or ink jets, for example. The active agents can also be disposed by way of electroless deposition, vapor deposition, casting, fusion or embedding processes.

For purposes of illustration and not limitation, the web materials of the present invention can be used to form a polymeric bag for storing perishable items, with the active agent(s) in communication with the environment inside such polymeric bag. The polymeric bag can be intended for consumer storage of food products (e.g., leftover food products) or commercial applications, such as “form, fill, and seal” food packaging operations. The polymeric bag can include non-reclosable or reclosable polymeric bags. Reclosable polymeric bag are typically made to be reclosable via reclosable elements or fasteners, such as resealable adhesive or cohesive seals, mated tracks, and/or mated dimples. The mated tracks can be opened and closed by applying finger pressure or by using an auxiliary device, such as a slider. Some examples of reclosable polymeric bags include the bags disclosed in U.S. Pat. Nos. 5,067,208 and 6,147,588 and U.S. Patent Application Publication No. 2004/0066985, the contents of which documents are expressly incorporated by reference herein in their entireties. These packages are often manufactured from a web of material initially disposed in roll form prior to forming of individual bags.

Further for purposes of illustration and not limitation, the active agents of the present invention can also be disposed in the environment of a rigid package for storing perishables, such as bakery containers, deli containers, fruit containers, lunch containers, processing trays, such as those for poultry or ground meat, and roaster containers. Some examples of containers include containers disclosed in U.S. Pat. Nos. 6,042,586, 6,257,401, 6,349,857, 6,644,494, 6,845,878 and U.S. Patent Application Publication Nos. 2004/0074902 and 2005/0000966, the contents of which documents are expressly incorporated by reference herein in their entireties. These can be are either of a “clam-shell” type, having a hinged lid or can be covered with a web material such as a film overwrap or lidding material. Such overwrap and lidding materials can be provided in the form of a web. The film overwrap preferably includes a cling layer, such that the film overwrap can be used to wrap the entire package. If lidding material is provided, a processing machine or “lidding machine” can be used to seal the lidding material to the rigid package. Such sealing is typically effected by virtue of heat sealing and the preselected material properties, but can also include the use of an adhesive.

Additionally for purposes of illustration and not limitation, the odor management agents of the present invention can be used in the environment of bags, liners and rigid trash containers for collecting garbage or waste and other containers for collecting items with undesirable odors, such as laundry and diapers. Such waste bags can include a tie feature that assists in closing the bag or liner securely, forming a handle for carrying the bag or liner to be disposed, and/or facilitating the opening of the bag or the liner. Some examples of waste bags include the bags disclosed in U.S. Patent Application Publication No. 2003/0223657, the contents of which document are expressly incorporated by reference herein in its entirety.

Illustrative embodiments will now be described to provide an overall understanding of the disclosed packages and related web materials and active agents. For purposes of illustration and not limitation, the packages of the present invention are described in the context of reclosable polymeric bags made from the subject web materials having active agent. Illustrative embodiments are provided in the drawings. Those of ordinary skill in the art will understand that each disclosed web material, package and/or bag having an active agent can be adapted and modified to provide alternative embodiments for other applications, and that other additions and modifications can be made to the disclosed web materials, packages and active agents without departing from the scope of the present disclosure. For example, features of the illustrative embodiments can be combined, separated, interchanged, and/or rearranged to generate other embodiments. Such modifications and variations are intended to be included within the scope of the present disclosure.

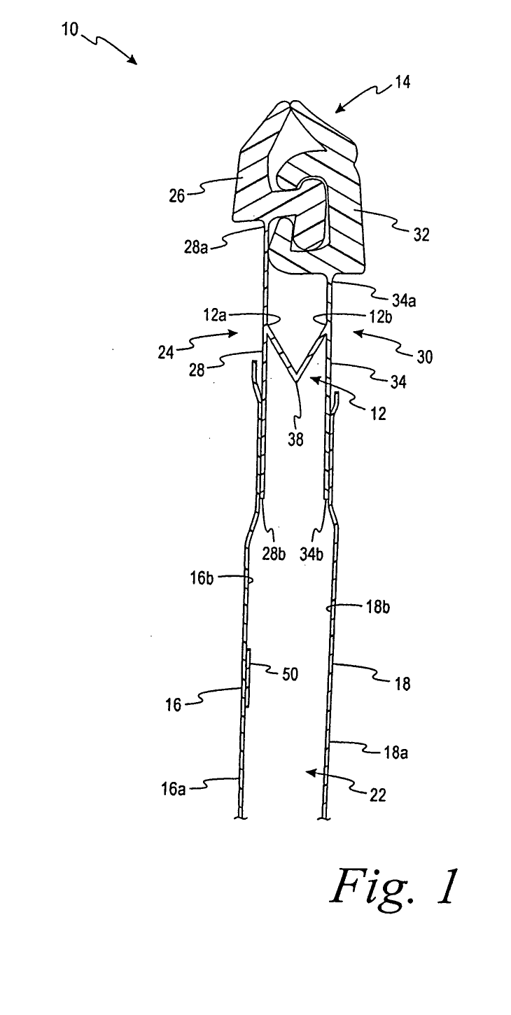

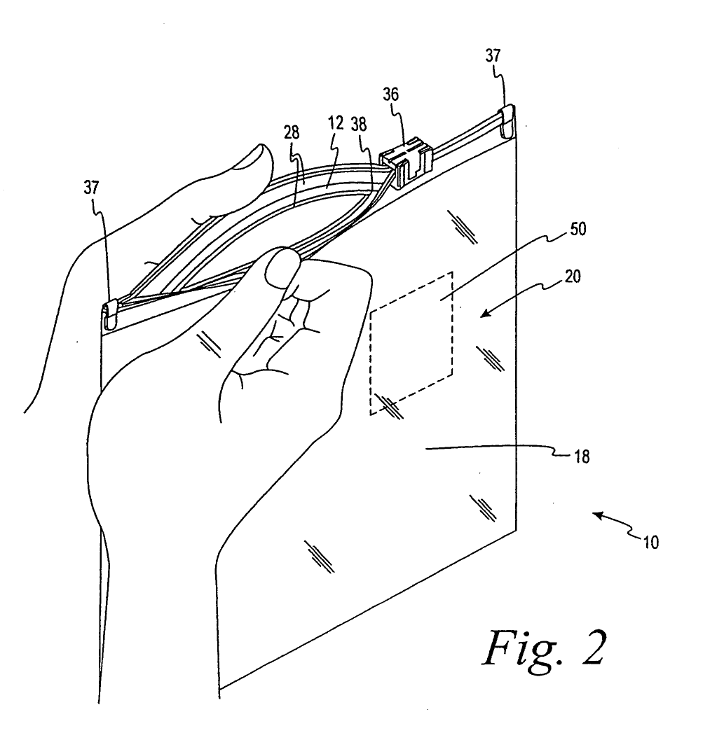

Turning now to the drawings, FIG. 1 depicts a mouth portion of a reclosable package 10 with an agent structure 50 containing an active agent. The agent structure 50 is located below a reclosable closure arrangement such as a fastener or zipper 14. FIG. 2 shows the reclosable package 10 with the mouth portion depicted in FIG. 1 in a partial open position.

Referring to FIGS. 1 and 2, the mouth portion of the reclosable package 10 includes a pair of first and second opposing body or wall panels 16, 18 that make up a package body 20 and define an interior space 22. Typically, the body or wall panels 16, 18 are formed from a web of stock material. The web can be provided certain features prior to forming into the body or wall panels. The web of material can be provided with any of the active agents set forth herein, prior to forming the reclosable package 10. Connected to the first body panel 16 is a first track 24 having a first profile 26 and a first fin portion 28 extending generally downward from the first profile 26. The first body panel 16 has an outer surface 16a and an inner surface 16b. Connected to the second body panel 18 is a second track 30 having a second profile 32 and a second fin portion 34 extending generally downward from the second profile 32. The second body panel 18 has an outer surface 18a and an inner surface 18b. The inner surface 16b is attached to the first fin portion 28. The inner surface 18b is attached to the second fin portion 34. It is contemplated that one or more of the fin portions can be attached to the outer surfaces 16a, 18a.

The first and second profiles 26, 32 are releasably engageable with each other to provide a reclosable seal to the package 10. An optional breakable element 12 that initially extends from the first fin portion 28 to the second fin portion 34 can be used. The breakable element 12 of FIG. 1 is depicted with an optional one-time breakable preferential area of weakness or preferential tear area 38 to form a one-time breakable tamper evident feature. It is not necessary that the breakable element 12 have the one-time breakable preferential area of weakness 38. For example, in some embodiments, the breakable element 12 includes a resealable adhesive or cohesive seal. The one-time breakable preferential area of weakness 38 can be a score line, a series of perforations, a thinned area or a highly oriented region. Additionally, the preferential area of weakness 38 can be made in a manner to separate by cutting therethrough. The preferential area of weakness 38 inhibits tampering with the reclosable package 10 prior to being opened.

The reclosable package 10 can further include an optional slider mechanism 36 (FIG. 2) slidably mounted to the fastener 14 for movement between a closed position and an open position. Referring to FIGS. 1 and 2, the first and second profiles 26, 32 are engaged to each other while the slider mechanism 36 is in the closed position, and movement of the slider mechanism 36 from the closed position to the open position disengages the profiles 26, 32 from each other.

The package 10 of FIG. 2 also includes end terminations 37. End terminations can have various purposes such as (a) preventing or inhibiting the slider mechanism 36 from going past the ends of the fastener 14, (b) interacting with the slider 36 to give a tactile indication of being closed, (c) assisting in inhibiting or preventing leakage from the package 10, and (d) holding the first and second profiles 26, 32 together and providing additional strength in resisting stresses applied to the profiles 26, 32 during normal use of the package 10. Further details concerning the construction and operation of the slider mechanism 36 and the end terminations 37 can be obtained from U.S. Pat. No. 5,067,208 to Herrington, Jr. et al., which is incorporated herein by reference in its entirety.

It is contemplated that other end terminations can be used instead of the above-described end terminations 37. For example, an end weld can be formed by heated bars pressed against the end of the fastener, ultrasonic welding, or other ways known in the art.

As illustrated in FIGS. 1 and 2, the reclosable package 10 of the present invention is opened by having a consumer grip the slider mechanism 36 and move it such that the first and second profiles 26, 32 of the respective first and second tracks 24, 30 are detached from each other. Next, the consumer tears open the breakable element 12 (if present) along the preferential area of weakness 38. Alternatively, the consumer may open the breakable element 12, if used, by cutting therethrough. The package can be resealed utilizing the fastener 14 and slider mechanism 36. Specifically, the consumer grips the slider mechanism 36 and moves it from the open position to the closed position so as to engage the complementary first and second profiles 26, 32.

A one-time breakable element 12 not only provides a consumer with the assurance that a newly purchased package has not been opened before, but also provides a good initial seal that preserves the freshness of the perishable contents of the package prior to its initial opening and can inhibit or prevent the active agent from being activated by an activation-triggering condition, such as moisture. Since the reclosable closure arrangements of FIG. 1 are located above the one-time breakable element, (i.e., the reclosable closure arrangement is further from the interior space), the operation of the reclosable closure arrangement is not hampered by the presence of the one-time breakable element.

As embodied in FIG. 1, an agent structure can be connected to the first body panel inner surface 16b or the body panel can be formed of the web material as described further, below. The active agent can include a substance known to provide a desired function or effect on a package or contents thereof. In some embodiments, the active agent includes a freshness-extension agent, which functions to extend the life or freshness of food products or other perishables disposed in the package. In other embodiments, the active agent includes an odor management agent, which functions to mask, neutralize, and/or reduce an undesirable odor or to produce an aromatic odor in the package. Further, the web material can include a color indicator and other active agents, as described above in more detail.

The agent structure 50 can be provided in a form and structure suitable for the desired effect of the agent and the structure of the package. For example, in some embodiments, the agent structure 50 can be in the form of a coating, a patch, a tape, a pouch, a combination thereof, or in any other form that can be carried by, or incorporated or integrated into the structure of the web material to form the package 10. Additionally or alternatively, the active agent can be printed onto an underlying layer of the web material, co-extruded therewith, sprayed, applied by dipping the web into the active agent, deposited by way of static attraction, cast, applied via electroless deposition, vapor deposition, fused or otherwise embedded into the web or through combinations of these methods. The selection of a mode for disposing the active agent on the web, such as in a coating, patch, pouch, or tape is often dependent on the type of active agent being used, and the desired indication. For example, an active agent in a powder form (e.g., minerals containing chemistry) can be placed in an air-permeable pouch, rather than a patch because it is often difficult to embed powders in a patch. Alternatively, an active agent in a powder form can be dusted onto and adhered to the web material, or mixed with the material of the web prior to extrusion. Non-limiting examples of powdery active agents that can be incorporated into the agent structure 50 include perlite, calcium carbonate, kaolin, and ASEPTROL® antimicrobial manufactured by Engelhard.

If a tape or patch is used to support the agent structure 50, the tape or patch can be formed of a web of the invention and further include an adhesive, a patch-like component, and/or a release system such as a slip additive which assists in inhibiting or preventing the agent structure from sticking to the adhesive. For example, the release system can be located on a surface of the tape or patch that is located distally from the surface that contacts the body panel to which the tape or patch is to be attached, so that sticking is inhibited or prevented when the package is wound into a roll. Materials such as siloxane and glycerol monostearate can be among the components of such a release system.

In accordance with another aspect of the present invention, the active agent can be extruded with the web material that ultimately forms the body panel 16. For example, the active agent can be blended into the web material, and thus the body panel, in oil or powder form, or can be distributed in the form of microcapsules in the material of the body panel 16. In a preferred embodiment, the active agent is microencapsulated prior to being integrated into the web material or package structure. Microencapsulation encloses the active agent within a polymeric material that can withstand heat during package processing and manufacturing, but which degrades, dissolves, or otherwise breaks open and releases the active agent upon contact with pre-determined environmental factors such as moisture. The active agent can be encapsulated into microcapsules, and the microcapsules can be interspersed with the molten material of the web material and extruded into the web material during bulk production.

The web material of body panel 16 can be otherwise impregnated with the active agent It is also contemplated that the active agent can be sprayed, brushed, coated, laminated, stamped, or otherwise applied onto the web material, and thus onto the body panel 16.

In some embodiments, the active agent includes one or more freshness-extension agents. The freshness-extension agent can be, for example, a natural oil, an anti-microbial, a modified atmosphere, or another substance that can extend the freshness or shelf life of food products or other perishables. For example, some non-limiting examples of freshness-extension ingredients include isothiocyanate such as allyl isothiocyanate (AIT) from natural sources, d-limonene, eugenol, allicin, isothymol, thymol, chlorine dioxide, hydrogen peroxide, sodium percarbonate, ascorbic acid, citric acid, cinnamic aldehyde, mustard, peppermint, spearmint, triclosan, Chinese chive (Allium tuberosum), cinnamon (Cinnamomum cassia), corni fructus (Cornus officinalis), allyl cyanide, 1-cyano-2,3-epithiopropane, allyl thiocyanate, Lactobacillus reuteri, methyl isothiocyanate, cinnamon bark oil, lemon grass oil, thyme oil, methyl jasmonate, tea tree oil, ethyl alcohol, Salicylaldehyde, carvacrol, cymene, essential oil extracts of various onions, essential oil extract of garlic, berry phenolic extracts from cranberry, cloudberry, raspberry, strawberry, and bilberry, ellagitannins from cranberry, cloudberry, raspberry, strawberry, and bilberry, essential oils from nutmeg, mint, clove, oregano, cinnamon, sassafras, sage, thyme and rosemary, vanillin, vanillyl alcohol, vanillic acid, diacetyl, natural honey, fluorine dioxide, carbon dioxide, modified atmospheres and combinations thereof. The modified atmosphere can include nitrogen, oxygen, sulfur dioxide, carbon monoxide, carbon dioxide and combinations thereof.

AIT, which can be naturally obtained from plants or perishables such as mustard and wasabi, is particularly advantageous as a freshness-extension agent for its anti-microbial properties. Preferably, the AIT is produced from plants such as mustard, which contains glucosinolate and myrosinase enzyme. Myrosinase and glucosinolate react with each other to produce AIT and, because the reaction involves hydrolysis, humidity activates AIT production. AIT has been shown to exhibit anti-bacterial and anti-microbial properties and, as it is released in a gaseous form throughout the package atmosphere, it enhances the atmosphere so as to inhibit bacterial growth and therefore extend perishable freshness. Hence, AIT-containing or AIT-producing products, including wasabi, horseradish and mustard in various forms, such as extract, powder, oil, or ground seed, can be used as the freshness-extension agent in embodiments of the present invention. AIT can be disposed in the form of microcapsules. References that describe the use of microcapsule include, for example, U.S. Pat. No. 6,818,296, U.S. Application Publication No. 2004/0051191, U.S. Application Publication 2005/0249952, U.S. Application Publication No. 2005/0208089, U.S. Application Publication No. 2005/0089548, and U.S. App. No. 2006/0013884.

In some embodiments, an AIT-containing freshness-extension agent can also be used in combination with another functional agent. For example, in one such embodiment, ground mustard seed is combined with an acid, which greatly enhances the production of AIT from mustard and, thus, the anti-microbial effect of mustard. Thus, if ground mustard seed is used as the freshness-extension agent, it can be combined, in a desired ratio, with anhydrous acid such as anhydrous citric acid for increased AIT production and, thus, enhanced freshness-extension function.

In accordance with another aspect of the invention, a functional agent can be provided in conjunction with another active agent to indicate the useful life of the active agent. For example, a color agent or a color indicator, can be provided for visually indicating the useful life, residual amount, or release status of the active agent. Alternatively, and additionally, the indication can be in the form of a scent or any other means detectable to the user. Such indicators provide a simple way to detect the release or consumption of the active agent, such that the consumer generally can determine the remaining life of the active agent. Thus, the indicator minimizes the waste that might be caused by discarding web material or package prematurely before complete release of the active agent. This allows for a more effective use of the active agent by informing the consumer of the need for replacement. Reference will be made to alternative color indicators for purpose of illustration, and not limitation.

Color change of the color indicator can be effected e.g., to correspond with the release of the active agent or amount of humidity in the package atmosphere, such as by moisture released by perishables contained in the package. For example, a “matched release” can be accomplished entrapping a color agent in microspheres or beads that are configured to degrade at a timed rate similar or matched with the rate of release of the active agent under similar environmental conditions.

The color indicator can gradually change color over time as the agent is released into the package atmosphere and the amount of residual agent is reduced, thus providing a “matched release,” corresponding to the release of the active agent. For example, a color indicator that initially shows yellow color can gradually change, corresponding to release of the agent, to a clear colorless state. Such color indicator also indicates the extent or amount of the residual agent by gradually changing or fading the tone or shade of color over time. A color chart can be provided for more precise measurement of remaining active agent of shelf life by matching the shade of the color indicator with a color scale on the color chart.

Any dye material or a material that can provide “matched release” can be used. For example, a food-grade methyl cellulose (MC), hydroxypropyl methyl cellulose (HPMC), or carboxy methyl cellulose (CMC) can be used. These materials dissolve in moisture, and can be provided such that the material dissolves at substantially the same rate as the life of the agent. Any commercially available food-grade MC, HPMC, or CMC can be used, e.g., Walocel® HM HPMC, Dow METHOCEL®, and Hercules Aqualon® and Benecel®.

In one embodiment, the agent structure contains methyl cellulose which has a different color from that of the structure. For example, methyl cellulose having a blue color is contained in a structure having a green color. As the agent is released and methyl cellulose dissolves in moisture, the color of the structure changes from blue to green, showing expiration of the agent.

The color indicator can also incorporate the technology disclosed in U.S. Pat. No. 6,124,219 to Fujita et al. and/or U.S. Patent Application Publication No. U.S. 2005/0129937, the entire contents of each of which is incorporated herein by reference thereto. For example, U.S. Pat. No. 6,124,219 discloses a functional material, comprising a volatile agent, an oil-soluble dye, and a porous carrier, which fades in color with the volatilization of a volatile agent. According to this patent, the volatile agent and an oil-soluble dye, which has a dissolving proportion of 0.0001 to 1%, are retained in the pores of a porous carrier that cannot be stained by the oil-soluble dye. The dye is dissolved in, and therefore stains, the volatile agent. The change in color of the functional material is therefore closely related to the dissolving proportion of the oil-soluble dye. Since the carrier has no affinity for the dye, the dye separates on the surface of the carrier when the volatile agent is volatilized nearly completely, and the functional material manifests the color of the carrier itself. Any suitable natural or synthetic dye, ink or coloring that is compatible with the active agent, i.e. one that does not adversely react with the active agent, can be used.

Alternatively, or additionally, the indicator can function as an “agent marker” that detects and indicates the existence of the agent in the package atmosphere. For example, a color indicator can have a yellow color when no active agent is detected, e.g., before activation of the active agent or after the active agent is depleted, and can display green color when the active agent detected.

The color indicator can be designed to indicate food spoilage or contamination, or presence of a particular gas, compound, or odor in the package atmosphere, in addition to the life or presence of the active agent. Such an indicator or detector is disclosed in U.S. Pat. Nos. 6,325,974; 5,306,466; 6,841,392; 6,576,474; 6,495,368; 6,361,962, and 5,439,648 and U.S. Patent Application Publication Nos. U.S. 2004/0142495 and U.S. 2005/0112085, the entire content of each of which is incorporated herein by reference thereto.

For example, U.S. Pat. No. 6,325,974 discloses a package for decayable foodstuffs having an indicator, which can change color when exposed to an atmospheric gas and/or a volatile compound produced as a result of decay of the foodstuff contained in the package. U.S. Pat. No. 5,439,648 also discloses a gas indicator for a modified atmosphere packaging. The indicator is adapted to change color at different predetermined ratios of gases contained in the package, and changes color if the package is tampered with and a gas enters into or escapes from the package. Hence, such indicators can be provided to detect the presence or absence of the desired active agent.

U.S. Pat. No. 5,306,466 discloses a food contamination detector in the form of a bar code. The bar code contains an antigenic determinant (antibody) of toxins or contaminants irreversibly bound to a transparent membrane. The antibody is further labeled with a colored latex bead such that, when toxins from food come in contact with the bar code and bind to the antibody, the color develops on the bar code. Instead of antibodies, a chemical indicator can be utilized, in accordance with the invention. U.S. Patent Application Publication No. U.S. 2004/0142495 discloses a similar method for detecting the presence or absence of an analyte with antibodies. U.S. Pat. No. 6,841,392 discloses use of multiple antibodies to detect biological materials that have reached a predetermined concentration or threshold level. Specific polymers can be incorporated such that binding of a biological material induces a molecular change in the polymer, resulting in a distinctly colored icon on the packaging material.

Instead of antibodies, metal complexes can be used to detect food spoilage, as disclosed in U.S. Pat. No. 6,593,142 and International Publication No. WO 00/13009, the entire contents of each of which is herein incorporated by reference thereto. For example, a metal complex that selectively binds biogenic amines or sulfur compounds can be used.

The indicator can change color or emit fluorescence based on a pH change or the presence of compounds resulting from microbial spoilage, including amines, carboxylic acids, and aldehydes, as disclosed in U.S. Pat. Nos. 6,576,474 and 6,495,368.

Alternatively, the indicator can be odor-sensitive, as disclosed in U.S. Patent Application Publication No. U.S. 2005/0112085, and can indicate, among others, garbage odor, raw meat odor, common household odors, cooking odors, mercaptans, amines, ammonia, sulfur, sulfides, and certain acids.

The color indicator can be carried by or disposed on the web material in the same manner as, or even with the active agent. For example, the color indicator can be disposed in the form of a coating, patch, pouch, or tape that is attached to the web material; extruded with a component of the web material; sprayed, brushed, coated, laminated, or stamped onto the web material; impregnated into a component of the web material; and/or distributed in the web material, such as in the form of microcapsules, or in any other manner described herein with respect to the active agent.

When disposed in the form of a separate agent structure carried by the subject web materials, a base layer also is provided for the agent structure. The base layer can be made of a diffusion material with the active agent contained therein, and/or can have the active agent disposed between the base layer and one or more removable covers. Alternatively or additionally, a diffusion layer can be disposed between the base layer and the removable cover(s) and/or a barrier layer can be provided on the base layer opposite the removable cover(s). The barrier layer, base layer and diffusion layers preferably are made of polypropylene, polyethylene, and ethylmethyl acrylate, respectively.

The freshness-extension agent can also provide other enhancement functions, and therefore can be used for such other purposes. In some embodiments, the active agent, e.g. the freshness-extension agent, can include a freshness component for extending food freshness and an odor component for masking, reducing, and/or neutralizing only a pungent odor of the freshness component, but not other odors of the contents stored in a package. Preferably, the odor component does not mask the odors of the contents stored in the package, such as food odors or food spoilage odors, so that decay or spoilage of the contents can be detected by smell. For example, a freshness-extension agent including an AIT freshness component can also include a fragrant component, such as vanilla, cinnamon, or citrus oil, which can mask the pungent odor of AIT, but not mask or otherwise affect the odor of the stored contents. Preferably, the freshness-extension agent does not impart its own organoleptic properties to the stored contents, and thus permits a user to readily detect decay or spoilage of stored contents by smell.

Alternatively, in some embodiments, the active agent includes one or more odor management agents. Advantageously, the odor management agent can be incorporated into the web materials to form packages configured for collecting garbage or waste to mask, neutralize, and/or reduce undesirable odors. Alternatively, the odor management agent can be used to provide or create an odor to a package. An odor management agent can thus be incorporated into thermoplastic bags or liners and other containers, such as garbage or waste bags, diaper containers, laundry bags, storage bags, and disposable medical bags or containers.

Non-limiting examples of odor management agents include AIT, d-limonene, mustard, natural oils, chlorine dioxide, hydrogen sulfide, methyl mercaptan, ammonia, citronella, pine, flowery, and substituted esters such as METAZENE®.

A preferred embodiment of an odor management agent includes AIT, which agent can be provided by incorporating, for example, mustard in the agent structure 50. Mustard, whether in the form of ground mustard seed, powder, oil, or paste, can be provided alone or in combination with an acid (such as citric acid) to catalyze the production of AIT from mustard and enhance the anti-microbial and odor management properties of the mustard. Because of its effectiveness in extending perishable freshness as previously described herein, AIT can provide multiple functions when incorporated into a perishable package, e.g., AIT can perform both freshness-extension and odor-management functions.

In some embodiments, the odor management agent can include an additional ingredient for providing a pleasant or desired odor or scent to a user. For example, a natural oil such as lemon grass oil can be used to manage odors emanating from a package, to mask the odor of the primary odor management agent itself, or to make the odor of the odor management more pleasant to a user. It has been shown that a composition comprising ground mustard seed and anhydrous citric acid mixed with about 5% by weight of lemon grass oil is particularly effective at managing unpleasant odors.

If the active agent includes an aromatic or perfumery ingredient for providing a desired scent to a package, an additional material for enhancing scent concentration in the interior of the package can be included. For example, the web material can include perlite to increase the scent concentration. Perlite is desirable for use because of its ability to retain scent, its stability, and its surface area. Non-limiting examples of other materials for enhancing scent include microspheres, talc, silicon, silicate such as aluminum silicate, vermiculite, diatomaceous earth, or combinations thereof.

Further in accordance with the invention, the web material or package can be provided with an activation system that is triggered automatically, such as when the reclosable package is opened or filled with contents. The activation system can be mechanical in nature, such as a perforation or a peel apart system that once separated initiates the release of the active agent. Another activation method can be based on the humidity or moisture level that is present in the package (e.g., which correlates to water activity of the contents). For example, a high amount of humidity can initiate a chemical or other reaction that subsequently releases a volatile chemical such as carbon dioxide or chlorine dioxide. In such an example, a greater amount of active agent is added when the humidity is higher in the reclosable package. Examples of reactions that are activated by a high humidity level are salt and acid reactions, such as sodium bicarbonate and citric acid, or sodium hypochlorite and citric acid. The release of AIT is also aided by humidity as previously explained. In such examples, a greater amount of active agent is released into the package atmosphere when the humidity increases.

During a method of operation of a reclosable package formed with the subject web materials having, for example, a humidity-activated freshness extension agent, perishables are placed in the interior of the package, and an increased humidity or moisture level in the perishables activates the freshness-extension agent. Preferably, the reclosable package is formed of a barrier material as described to inhibit activation of the active agent due to the surrounding environment. Additionally, if the agent structure is disposed proximate the mouth of a bag-like package or proximate the rim of a container-like package, selective activation or release can be accomplished. For example, the humidity or moisture level of the perishables can activate the agent as the perishables travel in the vicinity of the agent (e.g., through the mouth or past the rim of the package during the initial placement of the perishable products into the interior), while the perishable products remain disposed in the interior, and upon entry of air into the interior (e.g., during an opening of the package). Disposing the agent structure proximate the mouth or rim of a package can also be advantageous when maximum display of the contents is desired in a transparent package.

A humidity activation method can further be controlled by providing a barrier layer material. For example, it is preferable that the web materials provide a barrier layer or be formed of a barrier material so as to create an enclosed environment to prevent or inhibit the introduction of humidity and the release of active agent when a package formed from the web material is closed. As used herein, the terms “barrier layer” and “barrier material” include layers or materials that inhibit or otherwise control the release of an active agent into a package atmosphere, rather than being limited to layers or materials that completely block or prevent such release.

An example of a barrier material is polyethylene glycol (PEG) incorporated into low density polyethylenes (LDPE). Other materials providing a barrier to transfer of water, water vapor, oxygen, nitrogen, carbon dioxide, ethylene, volatile or non-volatile active agents include but are not limited to polymers, copolymers, blends, extrusions, co-extrusions, coatings, metallization or laminations of: low density polyethylene (LDPE), linear low density polyethylene (LLDPE), linear medium-density polyethylene (LMDPE), high density polyethylene (HDPE), very low density polyethylene (VLDPE), metallocene (mPE), polypropylene (PP), oriented polypropylene (OPP), acrylonitrile butadiene styrene (ABS), acrylonitrile-styrene-acrylate (ASA), acrylonitrile-EPDM-styrene (AES), ASA/AES copolymers, polyamide 6, polyamide 66 and their copolyamides, poly vinyl chloride (PVC), acrylic, polybutylene terephthalate (PBT), ethylene/ethyl acrylate (EEA), ethylene/vinyl acetate (EVA), modified polystyrene, ethylene-vinyl alcohol (EVAL or EVOH), polyvinylidene chloride (PVDC), liquid crystal polymer (LCP), polyamides, polyacrylic acid (PAA), polylactic acid (PLA), polyethylene terephthalate (PET), polyethylene terephthalate glycol (PETG), saran, ceramic filled polymers, nanocomposite polymers, polychlorotrifluoroethylene (PCTFE), polymethyl methacrylate (PMMA), acrylonitrile-methyl acrylate (AC-MA), polyphenylene ether (PPE), polyphenylene oxide (PPO), thermoplastic elastomer, cellophane, nylon, modified polyolefins with barrier properties, cyclic olefin copolymers, polyacrylonitriles, acrylonitrile copolymers, polyacetals, modified polyesters, acrylic derivatives, and inorganic barrier coatings.

Preferred barrier materials include metal foil, polyethylene terephthalate (PET), metallized polymers, such as metallized polyester, polyvinylidene chloride (PVDC), and ethylene vinyl alcohol (EVOH).

Preferred materials that are suitable for blocking the introduction of water vapor into a package include low density polyethylene (LDPE), linear low density polyethylene (LLDPE), linear medium-density polyethylene (LMDPE), high density polyethylene (HDPE), polypropylene (PP), oriented polypropylene (OPP), acrylonitrile-methyl-acrylate (AMA), poly vinyl chloride (PVC), PMMA, acrylic, ethylene/vinyl acetate (EVA), polyvinylidene chloride (PVDC), polyethylene terephthalate (PET), polyethylene terephthalate glycol (PETG), saran, ceramic filled polymers, nanocomposite polymers, polychlorotrifluoroethylene (PCTFE), polymethyl methacrylate (PMMA), acrylonitrile-methyl acrylate (AC-MA), modified polyolefins with barrier properties, cyclic olefin copolymers, polyacrylonitriles, acrylic derivatives, inorganic barrier coatings, foils and metallized polymers, polyvinylfluoride (PVF), ionomer, polyetherimide, Polyethylene naphthalate (PEN), Butyl rubber, and polychloroprene (Neoprene G).

Preferred materials that are suitable for blocking the release of active agents and/or oxygen from a package include high density polyethylene (HDPE), polypropylene (PP), oriented polypropylene (OPP), acrylonitrile-methyl-acrylate (AMA), poly vinyl chloride (PVC), PMMA, acrylic, polyvinylidene chloride (PVDC), polyethylene terephthalate (PET), polyethylene terephthalate glycol (PETG), saran, ceramic filled polymers, nanocomposite polymers, polychlorotrifluoroethylene (PCTFE), polymethyl methacrylate (PMMA), acrylonitrile-methyl acrylate (AC-MA), modified polyolefins with barrier properties, cyclic olefin copolymers, polyacrylonitriles, acrylic derivatives, inorganic barrier coatings, foils and metallized polymers, Polyvinylfluoride (PVF), Polyetherimide, Polyethylene naphthalate (PEN), Polyvinylidene fluoride (PVDF), polyimide, polyetheretherketone (PEEK),polyoxymethylene (POMC), polyacetal, acrylonitrile butadiene styrene (ABS), polyamide 6, polyamide 66 and their copolyamides, polybutylene terephthalate (PBT), thermoplastic polyester (TPE), modified polystyrene, ethylene-vinyl alcohol (EVAL or EVOH), polyamides, polylactic acid (PLA), cellophane, nylon, modified polyesters, and polyethersulfone (PES).

Of the foregoing materials, those that are suitable as barrier layers for blocking both the introduction of water vapor to and the release of active agents from a package include high density polyethylene (HDPE), polypropylene (PP), oriented polypropylene (OPP), acrylonitrile-methyl-acrylate (AMA), poly vinyl chloride (PVC), PMMA, acrylic, polyvinylidene chloride (PVDC), polyethylene terephthalate (PET), polyethylene terephthalate glycol (PETG), saran, ceramic filled polymers, nanocomposite polymers, polychlorotrifluoroethylene (PCTFE), polymethyl methacrylate (PMMA), acrylonitrile-methyl acrylate (AC-MA), modified polyolefins with barrier properties, cyclic olefin copolymers, polyacrylonitriles, acrylic derivatives, inorganic barrier coatings, foils and metallized polymers, Polyvinylfluoride (PVF), Polyetherimide, and Polyethylene naphthalate (PEN).

It is also contemplated that other barrier materials such as foils and metallized polymers such as metallized oriented polypropylenes (OPP) can be used. The barrier layer is substantially impermeable to at least water vapor and active agents, and, in some embodiments, also to oxygen, nitrogen, and carbon dioxide, or combinations thereof. The barrier layer thus inhibits or prevents water vapor (and, in some embodiments, oxygen, nitrogen, and carbon dioxide) from entering the interior of the package, while inhibiting or preventing the active agent from escaping the interior of the package. An example of a cyclic olefin copolymer that can be used in forming the barrier layer is TOPAS® 8007. Useful cyclic olefin copolymers are believed to be available from several companies. For example, Ticona, a business of Celanese AG, in Summit N.J. has cyclic olefin copolymers available. Other companies that are believed to have cyclic olefin copolymers available include Nippon Zeon (Japan), Mitsui Chemical (Japan) and JSR (Japan), formerly know as Japan Synthetic Rubber. Ticona, a business of Celanese AG, has commercially available cyclic olefin copolymers (COCs) under the designation TOPAS®. These cyclic olefin copolymers are believed to be prepared with feedstocks of norbornene and ethylene and the use of a metallocene catalyst. There are believed to be at least four grades of TOPAS® resins available (TOPAS® 8007, TOPAS® 6013, TOPAS® 6015 and TOPAS® 6017). The four grades of TOPAS® resins available have glass transition temperatures, Tg, of 80, 140, 160 and 180° C., respectively. The corresponding norbornene levels of the four grades of TOPAS® resins are 35, 48, 55 and 59 mole %.

Preferably, the web material includes thermoplastic materials. For example, a polymeric matrix layer can be provided for impregnating or supporting a microencapsulated active agent therein. The matrix layer of the agent structure 50 can be made of polyolefinic materials such as polyethylenes, polypropylenes, polystyrenes, and combinations thereof. Non-limiting examples of the matrix layer materials include polymers, copolymers or blends of: low density polyethylene (LDPE), linear low density polyethylene (LLDPE), linear medium-density polyethylene (LMDPE), high density polyethylene (HDPE), very low density polyethylene (VLDPE), metallocene (mPE), polypropylene (PP), polyamide 6 polyamide 66 and their copolyamide, poly vinyl chloride (PVC), acrylic, thermoplastic polyester (TPE), ethylene/vinyl acetate (EVA), polystyrene (PS), high impact polystyrene (HIPS), modified polystyrene, liquid crystal polymer (LCP), polyamides, polyacrylic acid (PAA), polylactic acid (PLA), polyethylene terephthalate glycol (PETG), polymethyl methacrylate (PMMA), polyphenylene ether (PPE), thermoplastic elastomer, and cellulose and filled plastics. These materials generally provide a good barrier to water vapor, but allow permeation of oxygen and active agents. Polyethylene is particularly advantageous because of its recyclability. Another example of a material that can be used to form the web material is ethyl methyl acrylate (EMA). A surface of web material can be formed of a porous non-woven material (e.g., gauze) that allows the active agent such as freshness extension, odor management agent or other active agent to be released. For odor management, one of the layers of the odor management structure can further include a fragrance (e.g., a liquid fragrance), a scent-enhancing mineral, and/or a polymeric resin (e.g., LLDPE).

As will be understood by those of ordinary skill in the art, the amount of agent to be used in combination with a package will depend on the environment in which the agent is in use, e.g., the loss and release rates of the agent. The release rate refers to the rate at which the agent is released into the interior of the package, and the loss rate refers to the rate at which the released agent escapes from the interior of the package. Preferably, the agents of the present invention are disposed in amounts such that the release rate of the agent is greater than the loss rate of the agent during a pre-determined “shelf life” or duration of use, so that the presence of agent in the interior of a package is replenished faster than it is lost, thus ensuring effective performance of the agent. The loss rate of the agent depends upon a variety of factors related to package design, construction, and use.

It is contemplated that additional layers can be used as part of the package to enhance performance of the active agent. For example, a barrier layer can assist in keeping the active agent, e.g., freshness-extension agent, in communication with the interior of the reclosable package and, thus, assist in preventing or inhibiting the freshness-extension agent from permeating through the body panel. Similarly, the barrier layer, when used to define the package, inhibits humidity or other activators from activating the active agent.

For example, and with reference to the package embodiment of FIG. 1, each of the opposing body panels 16, 18, preferably forms a barrier layer that is substantially impermeable to at least water vapor and active agents and, in some embodiments, also to oxygen, nitrogen, carbon dioxide, or combinations thereof. The opposing body panels 16, 18 thus can include, i.e., be at least partially formed from one or more of, the foregoing materials. The opposing body panels 16, 18 can include barrier layers located on exterior and/or interior surfaces of the packages.

Based upon the above, the web material of the invention, which includes a barrier layer with active agent carried thereon, can be used to form a portion of a package, such as a body panel, a lidding material or a wrap. Alternatively, the web material of the invention can be formed to define an agent structure for use with a package or as otherwise desired.

For purposes of illustration, disclosed packages of the present invention will now be further described herein with respect to freshness-extension agents incorporated in or carried by agent structures of the invention. Those of ordinary skill in the art will understand that the disclosed packages can be suitably modified to include other types of active agents.

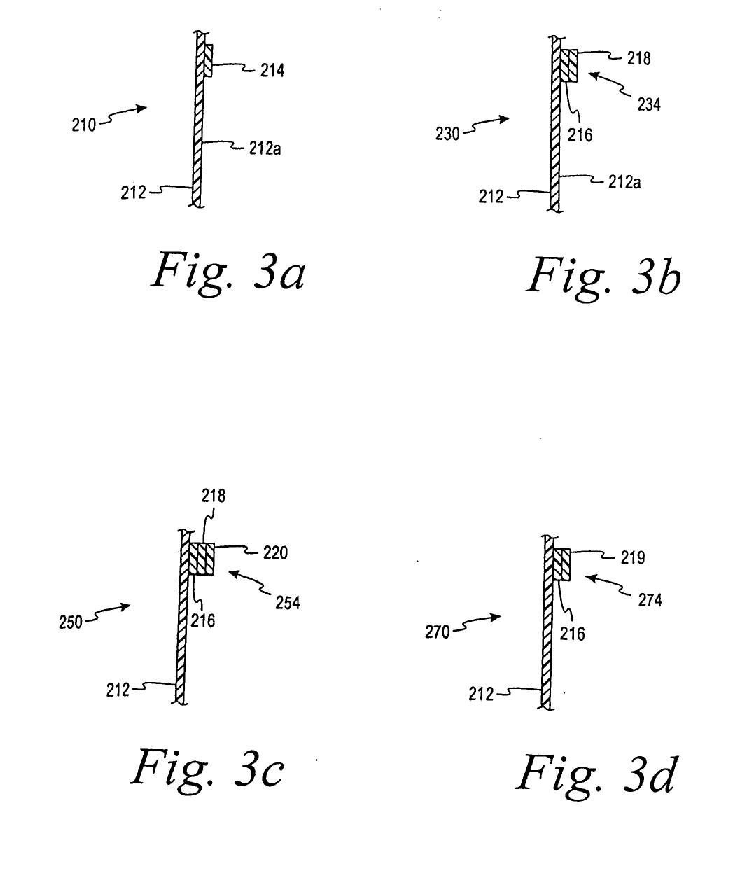

In one such embodiment, the barrier layer can define or otherwise be located on an inner surface of a freshness-extension structure as shown in, for example, FIG. 3a. In FIG. 3a, one side of a package 210 is depicted with a body panel 212 that includes a freshness-extension structure 214, and a second body panel (not shown in FIG. 3a). The freshness-extension agent of the freshness-extension structure 214 is in communication with the interior space, while one surface of the freshness-extension structure 214 is attached to a surface 212a of the body panel 212 via an adhesive, a heat seal, or a weld, e.g., an ultrasonic weld. It is contemplated that other attachment methods can be used. For example, the freshness-extension structure can be attached to at least one surface of the body panels, using mechanical methods such as clips or staples. Further, the freshness-extension structure can be provided as a coextrusion structure or as a laminate. Alternatively, it can be coated on a layer of film. In accordance with the invention, the web material thus includes the body panel 212 of the embodiment of FIG. 3a with the active agent disposed thereon.

Alternatively, and as previously noted, the web material can be formed into a separate agent structure, having a base layer with the active agent carried by the base layer. The base layer can be made of a barrier layer, or a diffusion material with the active agent contained therein, and/or can have the active agent disposed between the base layer and removable covers. Alternatively or additionally, a diffusion layer can be disposed between the base layer and the removable covers and/or a barrier layer can be provided on the base layer opposite the removable covers. The barrier layer, base layer and diffusion layers are, in one embodiment, preferably are made of polypropylene, polyethylene, and ethylmethyl acrylate, respectively.

The separate agent structure can be in the form of a patch, a tape or a pouch. By providing an adhesive, the agent structures can be adhered to a body panel of the package. If attached to the web material, that is, ultimately attached a wall or body panel of a package, such attachment can be facilitated by an adhesive, cohesive, fusion or weld connection. In alternate embodiments, the agent structures can simply be placed within the package.

One example depicted in FIG. 3b includes a reclosable package 230 comprising a first body panel 212, a second body panel (not shown in FIG. 3b), and a freshness-extension structure 234. The structure 234 comprises a first layer 216 that is a barrier layer and a second polymeric layer 218 that includes a freshness-extension agent. The first layer 216 can be a polymeric barrier layer using one of the previously mentioned barrier materials. One example of a polymer that can be used in the second polymeric layer 218 is a polyolefin such as a linear low density polyethylene (LLDPE). An outer surface 216a of the first layer 216 of FIG. 3b is attached to an inner surface 212a of the first body panel 212. The second polymeric layer 218 is directly adjacent to the first layer 216 so that the freshness-extension agent is in communication with the interior space. Depending on the materials that form the first and second layers 216, 218, it may not be necessary to adhesively attach the layers together. Rather, for example, the first and second layers can be co-extruded together if the materials for forming the first and second layers are compatible. In the embodiment of FIG. 3b, the body panel 212 need not be a barrier material, since a layer 216, providing barrier function is already provided, although it is preferred that the body panel 212 include barrier characteristics.

It is also contemplated that information can be printed on the freshness-extension structure 234 such as on the barrier layer. It is contemplated that the printing can occur on different locations of the structure. For enhanced visibility and readability of the printing, it may be desirable to print on the surface of the freshness-extension structure that is closest to the body panel when the structure is located in the interior of the reclosable package. For example, in FIG. 3b, the printing would be desirably located between the first body panel 212 and the first layer 216. If adhesive is used to attach the first layer 216 of FIG. 3b to the surface 212a, then the printing can be located between the adhesive and the first layer 216. It is contemplated that other attachment methods can be used such as a heat seal or mechanical methods.

Referring to FIG. 3c, a reclosable package 250 comprises a first body panel 212, a second body panel (not shown in FIG. 3c), and a freshness-extension structure 254 in the form of a patch or tape. It is contemplated that the structure can be in the form of a pouch or a coating. The freshness-extension structure 254 comprises a first layer 216 that is a barrier layer, and a second polymeric layer 218 that includes a freshness-extension agent, and a third polymeric layer 220 that is a diffusion layer. The first layer 216, as discussed above, can be a polymeric layer. The second polymeric layer 218 that includes the freshness-extension agent is located between the first and third layers 216, 220. One example of a polymer that can be used in the second polymeric layer 218 is a polyolefin, such as a linear low density polyethylene (LLDPE). The freshness-extension agent is in communication with the interior space of the reclosable package via the third polymeric layer 220 that is permeable. Thus, the third polymeric layer 220 controls the permeability and must be permeable to the extent that the freshness-extension agent can enter the interior of the reclosable package therethrough.

It is contemplated that the third polymeric layer 220 can comprise a cyclic olefin copolymer. The third polymer layer can comprise from about 10 to about 80 wt. % or, more specifically, from about 20 to about 40 wt. % cyclic olefin copolymer to assist in reducing curling of the polymeric structure. While not being bound by theory, curling tends to be caused when the materials forming the polymeric-structure layers are not as compatible with each other because of, for example, their different shrink rates. The barrier layer can comprise a more crystalline material that does not shrink much, if any, over time as compared to the diffusion layer that can comprise a material, such as polyethylene, that tends to shrink over time. The disadvantage of such structure curl is that the edges tend to curl in a transverse direction upon itself and therefore cause processing problems. The curling of the polymeric structure can be reduced or inhibited by using a cyclic olefin copolymer in the third polymeric layer, whereby the first layer and the third polymeric layer become more compatible. The addition of a cyclic olefin copolymer to the third polymeric layer 220 also slows the permeation of the freshness extension agent into the interior of the reclosable package 250.

As discussed above, it is contemplated that the freshness-extension structure 254 of FIG. 3c can have a release agent (e.g., a slip additive) that assists in preventing or inhibiting the polymeric structure from sticking to itself. It is also contemplated that information can be printed on the structure 254. The first layer 216 can be attached to the surface of the body panel(s), via an adhesive, heat seal or other methods.

Referring to FIG. 3d, a reclosable package 270 comprises a first body panel 212, a second body panel (not shown in FIG. 3d), and a freshness-extension structure 274 in the form of a patch or tape. It is contemplated that the structure 274 can be a pouch. The freshness-extension structure 274 comprises a first layer 216 being a barrier layer, and a second polymeric layer 219 being a diffusion layer and including a freshness-extension agent. The freshness-extension agent must be able to communicate with the interior space of the reclosable package or bag. The first layer 216 can be attached to the body panel 212, via an adhesive, a heat seal, a weld, or other methods.

The reclosable package can include more than one freshness-extension or “agent” structure that includes a freshness-extension agent therein. For example, the reclosable package can include two or three freshness-extension structures that each contain a freshness-extension agent.

A freshness-extension structure (e.g., a freshness-extension agent containing patch, tape, pouch, or coating) can vary in size and is dependent on factors such as the desired amount of freshness-extension, the particular freshness-extension agent being used, the number of freshness-extension structures being used in a package, and the size of the package. The dimensions of the freshness-extension structure are generally from about ½ inch or 1 inch to about 12 inches. Non-limiting examples of freshness-extension structure dimensions include ½ inch×1 inch, 1 inch by 1 inch, ½ inch×2 inches, 1 inch×6 inches, 2×4 inches, and 4×12 inches. The thicknesses of the freshness-extension structures can vary in the present invention but are generally less than about 20 mils. In some embodiments, the thickness of the structures is preferably about 12 to 16 mils, and more preferably about 14 to 15 mils. In other embodiments, the thickness of the structures is preferably about 5 to 10 mil, and more preferably 5 to 6 mil.

According to another embodiment, the freshness-extension structure can include a non-woven matrix. The non-woven matrix can be impregnated after the non-woven matrix has been formed. The impregnation of the non-woven matrix can be accomplished by a freshness-extension agent coating. Alternatively, the non-woven matrix can be initially formed with the freshness-extension agent therein. According to a further embodiment, the freshness-extension agent of the agent structure can be micro-encapsulated in a freshness-extension structure.

The freshness-extension structure being a patch, tape, pouch, or coating in one embodiment is located in, or in communication with the interior of a package or bag, such as the reclosable package 10. For example in FIG. 3a, a partial cross-sectional view of one side of the reclosable package 210 is depicted with the body panel 212 and the freshness-extension structure 214. The structure 214 is attached to an interior surface 212a of the body panel 212 in which the interior surface 212a forms an interior portion of the reclosable package 210.

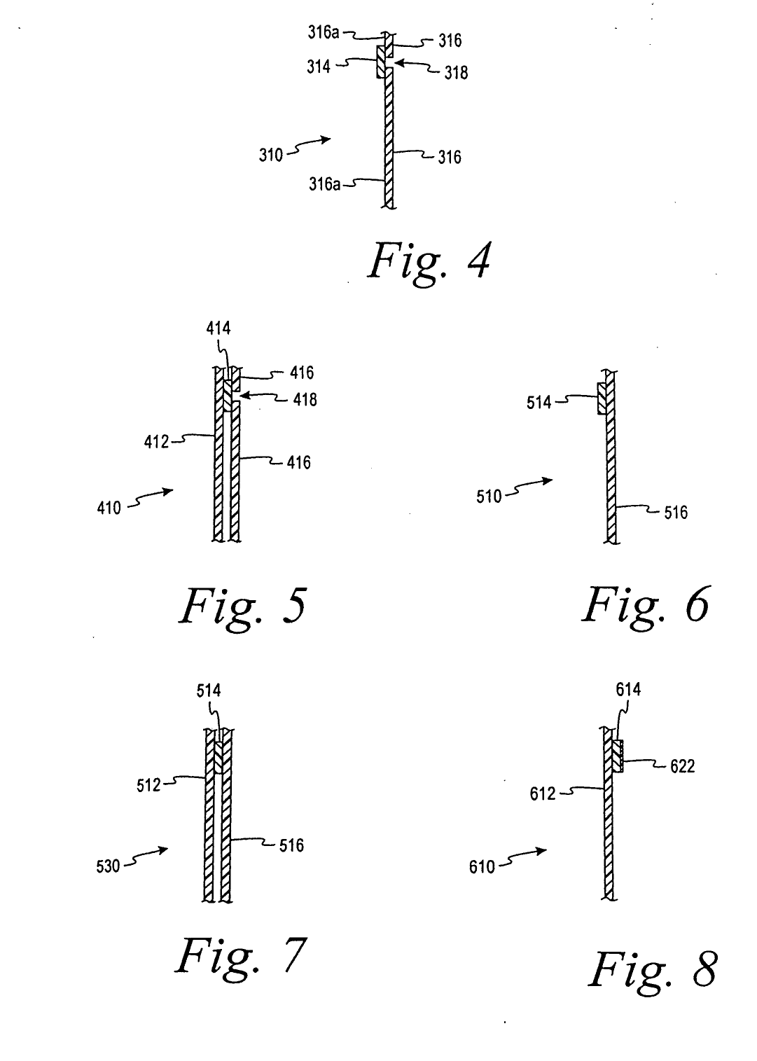

Alternatively, the freshness-extension structure being a coating, patch, pouch, or tape can be located on an exterior surface of an article or within layers of an article such that the freshness-extension agent is able to permeate into or communicate with the interior of the reclosable package. For example, the freshness-extension structure being a coating, patch, pouch, or tape can be located on the web material so as to be on an exterior surface of a reclosable package in which a portion of the body panel is removed such that the freshness-extension agent from the freshness-extension structure can permeate into the interior of the reclosable package. For example, referring to FIG. 4, a partial cross-sectional view of a web material for forming at least one side of a reclosable package 310 is shown with a freshness-extension structure 314 attached to an exterior surface 316a of a body panel 316. The body panel 316 has at least one opening 318 that allows the freshness-extension agent from the freshness-extension structure 314 to permeate into the interior of the reclosable package 310. The opening(s) 318 can be one large opening or a plurality of smaller openings that extends from and through the body panel 316 of the reclosable package 310. The opening(s) 318 can be formed by processes known in the art including a perforation process.

In another example, FIG. 5 depicts a partial cross-sectional view of a web material for forming at least one side of a reclosable package or bag 410. The reclosable package or bag 410 comprises an exterior layer 412, a freshness-extension structure 414, and an interior layer 416 with opening(s) 418. The freshness-extension structure 414 is located between and attached to the exterior layer 412 and the interior layer 416. The opening(s) 418 allows the freshness-extension agent from the structure 414 to be in communication with the interior of the reclosable package or bag 410. The freshness-extension structure can be inserted between the interior layer 416 and exterior layer 412 during manufacture of the web material, prior to forming the web material into the reclosable package or bag 410.

It is contemplated that a layer of a reclosable package can be permeable to the freshness-extension agent of the freshness-extension structure such that the freshness-extension agent is in communication with the interior of the reclosable package. FIG. 6 depicts such an example where a partial cross-sectional view of a web material for forming a reclosable package 510 is shown. The reclosable package 510 comprises a freshness-extension structure 514 and a diffusion layer 516. The diffusion layer 516 allows the freshness-extension agent from the freshness-extension structure 514 to enter the interior of the reclosable package. The freshness-extension structure 514 can be attached to the diffusion layer 516 during manufacture of the web material, prior to forming the web material into the reclosable package or bag 510.

The diffusion layer 516 can be made of a suitable material that allows the freshness-extension agent to reach the interior of the reclosable package in a relatively quick fashion. Thus, materials providing permeation of water, water vapor, oxygen, nitrogen, carbon dioxide, ethylene, volatile actives or nonvolatile active agents can be used for the diffusion layer. Examples of a diffusion layer 516 include polymers, copolymers, blends, extrusions, co-extrusions, coatings or laminations of: low density polyethylene (LDPE), linear low density polyethylene (LLDPE), very low density polyethylene (VLDPE), metallocene (mPE), polypropylene (PP), acrylonitrile butadiene styrene (ABS), polyamide 6, polyamide 66 and their copolyamides, poly vinyl chloride (PVC), acrylic, polybutylene terephthalate (PBT), thermoplastic polyester (TPE), ethylene/ethyl acrylate (EEA), ethylene/vinyl acetate (EVA), polystyrene (PS), high impact polystyrene (HIPS), modified polystyrene, ethylene-vinyl alcohol (EVAL or EVOH), polyacrylic acid (PAA), polylactic acid (PLA), filled polymers, hydrophilic nanocomposite polymers, polymethyl methacrylate (PMMA), thermoplastic elastomers, polydimethylsiloxane (PDMS), polymethylpentene (PMP), polyvinyl acetate (PVA), polyvinyl alcohol (PVAL), and cellulose acetate (CA), all of which have general affinity for moisture.

As will be understood by those of ordinary skill in the art, the same type of polymer material can be used in forming either the matrix, barrier, or diffusion layer, depending on the percentage ratio of the material in the layer composition, the quantity of the material in the layer composition (e.g., the thickness of the layer composition), and/or the method of fabrication. Thus, the use of a particular polymer material as a component for the matrix, barrier, or diffusion layer depends on its amount and manner of use.

FIG. 7 depicts another embodiment with a partial cross-sectional view of a web material for forming at least one side of a reclosable package 530 that includes an additional layer (exterior layer 512) as compared to the reclosable package 510 of FIG. 6.

It is contemplated that additional layers can be added in forming the web materials and reclosable packages shown in FIGS. 3-7. For example, an ethylene vinyl alcohol (EVOH) copolymer or polyvinylidene chloride layer (PVDC) can be used in forming the body panels of the reclosable package, or in forming a barrier layer of the package. Such a barrier layer assists in keeping the freshness extension ingredient in communication with the interior of the reclosable package. Other layers, such as a freshness-extension enhancing layer, are also contemplated. A freshness-extension enhancing layer can operate to enhance delivery of the freshness extension agent with increasing humidity. Such a freshness-extension enhancing layer is particularly advantageous, since increased humidity often results in a corresponding increase in bacterial growth that leads to increased perishable spoiling. One example of a freshness extension enhancing layer is polyvinyl alcohol (PVOH).

The freshness-extension structure can include one or more peelable covers. An example of such an embodiment is depicted in FIG. 8 where a partial cross-sectional view of a web material for forming one side of a reclosable package 610 comprises a body panel 612, a freshness-extension structure 614, and a peelable cover 622. The peelable cover 622 covers at least a portion of the freshness-extension structure 614 and may cover the entire freshness-extension structure 614 that is exposed in the interior of the reclosable package 610. The peelable cover 622 prevents or inhibits the freshness-extension agent from escaping the freshness-extension structure 614 in its initial position shown in FIG. 8. The peelable cover can be attached to the body panel 612 and/or the freshness-extension structure 614. The peelable cover 622 is removed by a user from the freshness-extension structure 614 to enhance or begin the release of the freshness-extension agent from the freshness-extension structure 614. Typically, the removal of the peelable cover 622 by the user occurs when a package is going to have perishable placed into it. One example of the peelable cover 622 is a barrier layer such as EVOH or PVDC. It is contemplated that a peelable cover can be used with any of the freshness-extension structures that are in the form of a patch, tape, or pouch.

According to one embodiment, a reclosable package is adapted to store items and comprises a first thermoplastic body panel, a second thermoplastic body panel, and at least one polymeric freshness-extension structure adapted to extend the freshness of items by increasing the time items can be stored in the article without spoiling. The first and second body panels are joined along a pair of opposing sides and a bottom bridging the sides so as to form an open mouth. The joined first and second body panels form an interior space for storing items. The polymeric freshness-extension structure is attached to a surface of the web material that forms one or more of the first and second body panels, and is in communication with the interior space. The freshness-extension structure further includes a peelable cover in which the peelable cover is adapted to initially cover at least a portion of the polymeric freshness-extension structure.

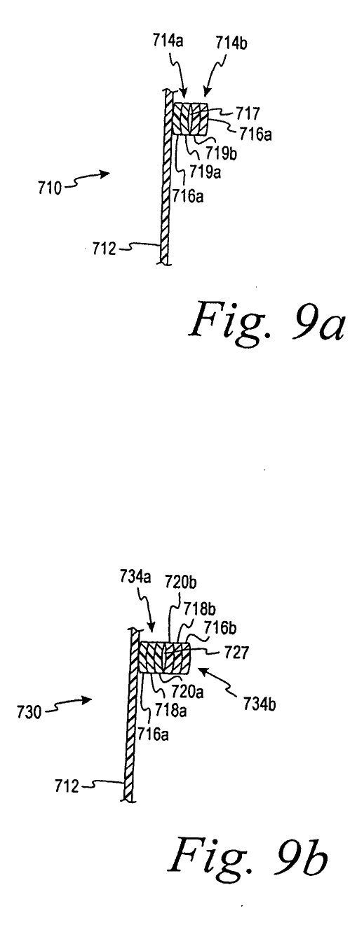

According to another embodiment, a web material can be provided that yields a reclosable package having two freshness-extension structures. For example, referring to FIG. 9a, a reclosable package 710 comprises a first thermoplastic body panel 712, a second thermoplastic body panel (not shown in FIG. 9a) a first freshness-extension structure 714a, and a second freshness-extension structure 714b. As discussed above, the first and second body panels are joined along a pair of opposing sides and a bottom bridging the sides so as to form an open mouth. The joined first and second body panels form an interior space for storing items.

The first freshness-extension structure 714a comprises two layers and is a patch or tape. It is contemplated that the first and second freshness-extension structures can form a pouch. The first freshness-extension structure 714a comprises a first layer 716a being a barrier layer, and a second polymeric layer 719a being a diffusion layer and including a freshness-extension agent. The first layer 716a can be a polymeric layer. The second polymeric layer 719a is directly adjacent to the first layer 716a. The first layer 716a is shown in FIG. 9a as being attached to the web material which forms the first body panel 712 via an adhesive, heat seal or other methods.

Similarly, the second freshness-extension structure 714b comprises two layers and is a patch or tape. The second freshness-extension structure 714b comprises a third layer 716b being a barrier layer, and a fourth polymeric layer 719b being a diffusion layer and including a freshness-extension agent. The fourth polymeric layer 719b is directly adjacent to the third layer 716b. The third layer 716b can be a polymeric layer. The second polymeric layer 719a is releasably heat sealed at selected locations to the fourth polymeric layer 719b such that the respective freshness-extension agent permeates into the interior of the reclosable package 710 via interior area 717.

The interior area 717 can be formed by having the first and second freshness-extension structures 714a, b curl with respect to each other. As shown in FIG. 9a, the interior area 717 is formed between the second and fourth polymeric layers 719a, b. A slight curl of the freshness-extension structures enables the freshness-extension agent to be in communication with the interior of the reclosable package. It is desirable to have some curl in the embodiment depicted in FIG. 9a to assist in enabling the freshness-extension agent to be in communication with the interior of the reclosable package or bag. As discussed above, the curling of the freshness-extension structures can be formed from using materials for forming the freshness-extension structures that are less compatible (i.e., the shrink rates of the materials differ).

It is contemplated that additional layers can be used in forming the two freshness-extension structures. For example, in FIG. 9b, a reclosable package 730 comprises a first thermoplastic body panel 712, a second thermoplastic body panel (not shown in FIG. 9b), a first freshness-extension structure 734a, and a second freshness-extension structure 734b. The first and second body panels are joined along a pair of opposing sides and a bottom bridging the sides so as to form an open mouth. The joined first and second body panels form an interior space for storing items.

The first freshness-extension structure 734a comprises three layers and is a patch or tape. It is contemplated that the first and second freshness-extension structures can form a pouch or a coating. The first freshness-extension structure 734a comprises a first layer 716a being a barrier layer, a second polymeric layer 718a comprising a freshness-extension agent, and a third polymeric 720a being a diffusion layer. The first layer 716a can be a polymeric layer. The second polymeric layer 718a is located between the first and third layers 716a, 720a. The first layer 716a is shown in FIG. 9b as being attached to the web material that forms the first body panel 712 via an adhesive or heat seal such that the freshness-extension agent is in communication with the interior space. It is contemplated that other attaching methods can be used such as mechanical devices like clips or staples.

Similarly, the second freshness-extension structure 734b comprises three layers and is a patch or tape. The second thermoplastic freshness-extension structure 734b comprises a fourth layer 716b being a barrier layer, a fifth polymeric layer 718b comprising a freshness-extension agent, and a sixth polymeric layer 720b being a diffusion layer. The fourth layer 716b can be a polymeric layer. The fifth polymeric layer 718b is located between the fourth and sixth polymeric layers 716b, 720b. The third polymeric layer 720a is heat sealed at selected locations to the sixth polymeric layer 720b such that the respective freshness-extension agent of the second polymeric layer 718a and the fifth polymeric layer 718b is adapted to enter the interior space of the reclosable package between the third polymeric layer 720a and the sixth polymeric layer 720b.

As discussed above, an interior area 727 can be formed by having the first and second freshness-extension structures 734a, 734b curl with respect to each other. As shown in FIG. 9b, the interior area 727 is formed between the third and sixth polymeric layers 720a, 720b.

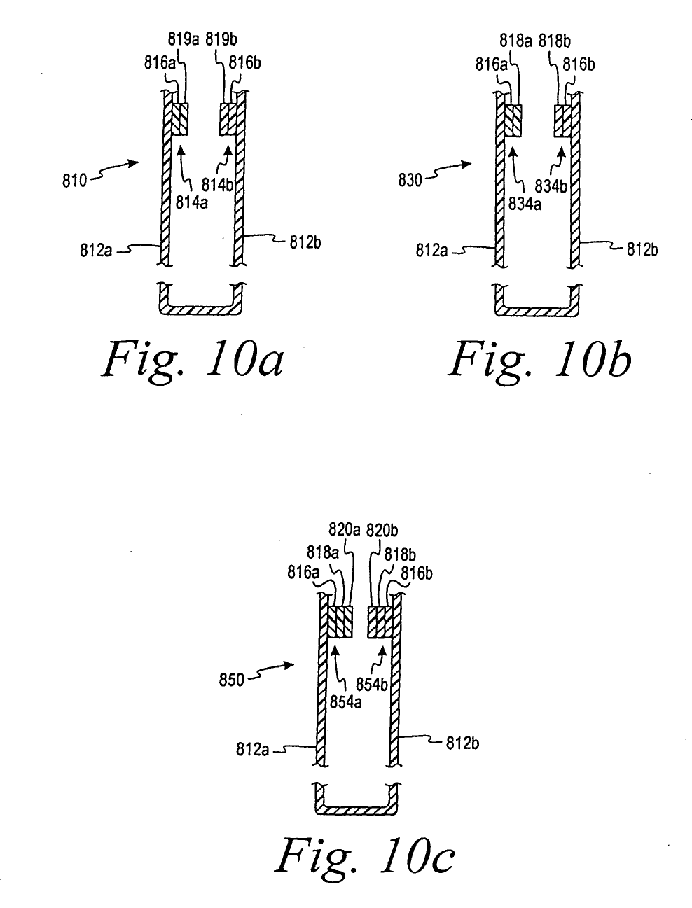

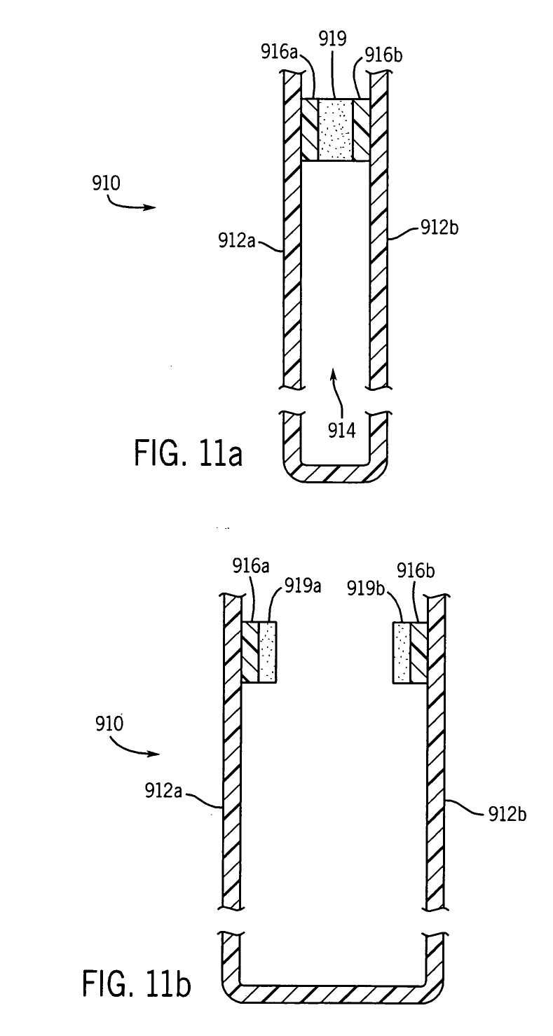

According to another embodiment, a reclosable package 810 is shown in FIG. 10a comprising a first thermoplastic body panel 812a, a second thermoplastic body panel 812b, a first freshness-extension structure 814a, and a second freshness-extension structure 814b. The first and second body panels 812a, 812b are joined along a pair of opposing sides and a bottom bridging the sides so as to form an open mouth. The joined first and second body panels form an interior space for storing items.

The first freshness-extension structure 814a comprises two layers and is a patch or tape. It is contemplated that the first and second freshness-extension structures can be in the form of a pouch. The first freshness-extension structure 814a comprises a first layer 816a being a barrier layer, and a second polymeric layer 819a being a diffusion layer and including a freshness-extension agent. The first layer 816a can be a polymeric layer. The second polymeric layer 819a is directly adjacent to the first layer 816a. The first layer 816a is shown in FIG. 10a as being attached to the web material, which forms the first body panel 812a via an adhesive or heat seal. It is contemplated that other attachment methods may be used. To adhere to the web material, which forms the first body panel 812a, the first layer 816a can include a coating that is not sticky or tacky at room temperature. Such a coating may become sticky, for example, at higher temperatures, or upon exposure to infrared radiation or heat.

Similarly, the second freshness-extension structure 814b comprises two layers and is a patch or tape. The second freshness-extension structure 814b comprises a third layer 816b being a barrier layer, and a fourth polymeric layer 819b being a diffusion layer and including a freshness-extension agent. The third layer 816b can be a polymeric layer. The fourth polymeric layer 819b is directly adjacent to the third layer 816b. The third layer 816b is shown in FIG. 10a as being attached to the web material, which forms second body panel 812b via an adhesive or heat seal. It is contemplated that other attachment methods may be used. To adhere to the web material, which forms the second body panel 812b, the third layer 816b may include a coating that is not sticky or tacky at room temperature. Such a coating may become s sticky, for example, at higher temperatures, or upon exposure to infrared radiation or heat.

It is contemplated that the first freshness-extension structure and the second freshness-extension structure can be formed of different compositions. For example, the first structure can include a first freshness-extension agent, while the second structure may be a second freshness-extension agent, and may include a color indicator, for example. In forming such an embodiment, the first and second freshness-extension structures can, for example, be formed by extruding two different patches, tapes, pouches, or by applying two different coatings.

Alternatively, the reclosable package can be formed by other than two or more layer structures. For example, a barrier layer need not be provided if the web material used to form the body panels 812 are formed of a material suitable to function as a barrier layer. Furthermore, as shown in FIG. 10b, a reclosable package 830 includes a first freshness-extension structure 834a that comprises a first layer 816a that comprises a freshness-extension agent, and a second polymeric layer 818a that is a diffusion layer. The reclosable package 830 also includes a second freshness-extension structure 834b that comprises a third layer 816b that comprises a freshness-extension agent, and a fourth polymeric layer 818b that is a diffusion layer. It is contemplated that the first and second freshness-extension structures can be made of different compositions, such as being made of different freshness-extension agents or diffusion layers.

According to yet another embodiment, the reclosable package can be formed by three or more layers. For example, as shown in FIG. 10c, a reclosable package 850 made from a web material in accordance with the invention includes a first freshness-extension structure 854a that comprises a first layer 816a that is a barrier layer, a second polymeric layer 818a that comprises a freshness-extension agent, and a third polymeric layer 820a that is a diffusion layer. The reclosable package 850 includes a second freshness-extension structure 854b that comprises a fourth layer 816b that is a barrier layer, a fifth polymeric layer 818b that comprises a freshness-extension agent, and a sixth polymeric layer 820b that is a diffusion layer. The first and second freshness-extension structures 854a, b are attached to first and second body panels 812a, 812b, respectively, via an adhesive or heat seal. It is contemplated that the first and second structures can be made of different compositions, such as being made of different barrier materials or freshness-extension agents.

As previously described, the freshness-extension agents of the present invention can contain an activation system that is triggered by a user opening a reclosable package or placing contents therein. In some embodiments, such as the embodiment shown and described with respect to FIG. 8, the activation system of the freshness-extension agents of the present invention is mechanical in nature. For example, in the embodiment of FIG. 8, the activation system includes a perforation or a peel-apart system which, once separated, initiates the release of the freshness-extension agent.

In accordance with another such aspect of the invention, a reclosable package 910, made from a web material in accordance with the invention, is shown in FIG. 11a, including a first thermoplastic body panel 912a, a second thermoplastic body panel 912b, and a freshness-extension structure 914 disposed therebetween. The first and second body panels 912a, 912b are joined along a pair of opposing sides and a bottom bridging the sides so as to form an open mouth. The joined first and second body panels form an interior space for storing items. The freshness-extension structure 914 can be in the form of a patch or tape as embodied herein, and comprises three layers. Particularly, the freshness-extension structure 914 depicted in FIG. 11a comprises a first layer 916a being a barrier layer, a second polymeric layer 919 being a frangible diffusion layer with a freshness-extension agent, and a third layer 916b being a barrier layer.

As shown in FIG. 11a, the second layer 919 is a one-time breakable element extending between the first barrier layer 916a and the second barrier layer 916b. The one-time breakable element of the second layer 919 therefore inhibits or prevents the freshness-extension agent from escaping into the package while in its initial position shown in FIG. 11a.

The one-time breakable element 921 can include one or more polymeric resins and polyolefins, and can be used with any of the previously-described freshness-extension structures. Polyolefins used as one-time breakable element include, but are not limited to, polyethylenes, polypropylenes, and combinations thereof. Some non-limiting types of polyethylenes include low density polyethylenes (LDPE), linear low density polyethylenes (LLDPE), high density polyethylenes (HDPE), medium density polyethylenes (MDPE) and combinations thereof. Other non-limiting examples include plastomers, elastomers, ethylene vinyl acetates (EVA), ethyl methacrylates, polymethylpentene copolymers, polyisobutylenes, polyolefin ionomers, cyclic olefin copolymers (COCs), or combinations thereof, including with polyethylenes and/or polypropylenes.

The one-time breakable element of the second layer 919 can include a one-time breakable preferential area of weakness or preferential tear area similar to the preferential areas of weakness or tear areas previously described herein or a one-time breakable adhesive or cohesive seal. Alternatively, the second layer 919 can be formed by selectively cross-linking the diffusion material to define the one-time breakable element. Generally, the bond between the second layer 919 and the adjacent layers must be stronger than the frangible portion of the one-time breakable element that joins portions 919a and 919b as described further below.

As shown in FIG. 11b, breakage of the one-time breakable element divides the second layer 919 into a first portion 919a and a second portion 919b, each having a surface exposed, and thereby begins or enhances the release of freshness-extension agent thereto. Typically, breakage of the one-time breakable element by a user occurs when the package is initially opened to place contents therein.

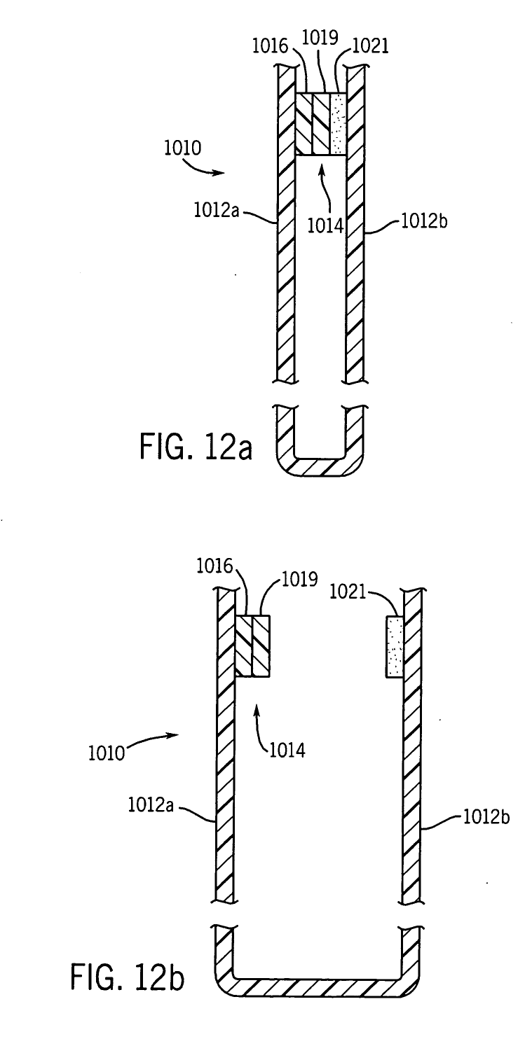

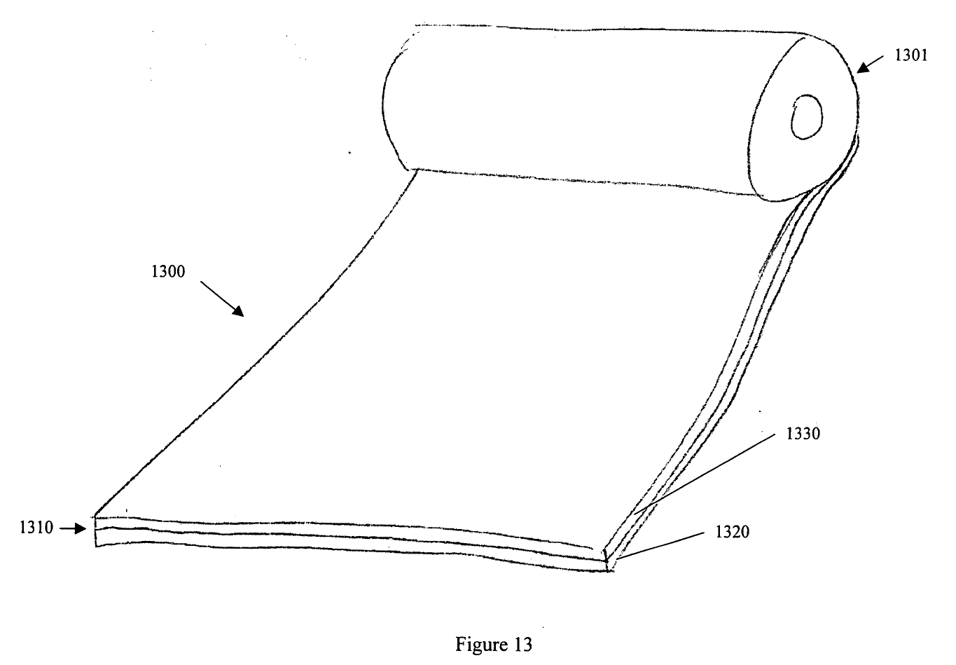

In another such embodiment having a mechanical release mechanism, a reclosable package 1010, made from a web material in accordance with the invention, is shown in FIG. 12a comprising a first thermoplastic body panel 1012a, a second thermoplastic body panel 1012b, a freshness-extension structure 1014, and a removable or peelable cover 1021. The first and second body panels 1012a, 1012b are joined along a pair of opposing sides and a bottom bridging the sides so as to form an open mouth. The joined first and second body panels form an interior space for storing items. The freshness-extension structure 1014 is in the form of a patch or tape and comprises two layers, e.g., a first layer 1016 being a barrier layer and a second polymeric layer 1019 being a diffusion layer and including a freshness-extension agent.

As shown in FIG. 12a, the removable cover 1021 is similar to that of FIG. 8, but is securely attached to panel 1012b. The removable cover 1021 covers at least a portion of the second layer 1019, and, as shown, preferably covers the entire second layer 1019 that is otherwise exposed in the interior of the package 1010. As shown in FIG. 12b, removal of the cover 1021 exposes the freshness-extension layer 1019 to the interior of the package 1010 and thereby begins or enhances release of freshness-extension agent thereto at least while the package is open. This embodiment of FIGS. 12a and 12b is particularly suitable for waste bags and liners or the like.

Alternatively, in some embodiments, the removable cover 1021 can cooperate with a slider of the fastener of the reclosable package 1010, so that the removable cover can be removed from the freshness-extension layer when the reclosable package 1010 is opened via the slider.

As set forth above, the subject web material can be used in processes to form the foregoing reclosable containers. The web material is used as a film to construct the body panels, or walls of the foregoing reclosable packages. The web material is either manufactured in a separate manufacturing process, or in-line with and preceding forming of containers with the web material. These containers include, but are not limited to rigid containers, bags, wraps and foils. The previous exemplary embodiments are directed to a web material including a first layer having an active agent carried thereon by an agent structure. Reference will now be made to alternative web material constructions of the invention.

FIG. 13 illustrates a web material 1300 in accordance with another aspect of the invention. As illustrated, the web material 1300 is disposed in a roll 1301, and includes two layers 1320 and 1330, joined along an interface 1310. As embodied herein, the first layer 1320 preferably acts as a barrier layer and the second layer 1330 preferably acts as a diffusion layer. Active agents, can be disposed either within the second layer 1330, or between the first layer 1320 and the second layer 1330. The first layer 1320, as a barrier layer, preferably inhibits passage of water and active agent, while the second layer 1330, as a diffusion layer, allows passage of at least active agent vapor. Depending on the intended use, permeability to both water vapor and active agent vapor is desired through the second layer. In certain embodiments, the diffusion layer not only is permeable to water vapor but is hydrophilic. If desired, an increased resistance to diffusion through the barrier layer can be achieved by increasing the thickness of the barrier layer. By contrast, and as set forth above, inhibition of the passage of solid, liquid and vapor phases of water and active agent through the barrier layer is desirable. Any of the barrier and diffusion materials set forth herein, or other suitable materials can be utilized. In a preferred embodiment, the barrier materials include polypropylene (PP) or polyethylene terephthalate (PET), and the diffusion materials include polymers such as ethylene methyl acrylate (EMA), ethylene vinyl-acetate (EVA) or Nylon, for example.

The web material of FIG. 13 advantageously releases active agent from the surface of the second layer, which can be aligned with or positioned adjacent the food or other perishable product. This feature is advantageous regardless of the form of the web material e.g., a wrap, material or bag. Furthermore, and in accordance with another aspect of the invention, the second material layer has a predetermined material property. For example, if intended for use as a food wrap, it is preferable that the diffusion layer embodied herein include cling characteristics, such as through inclusion or use of one or more cling materials. Preferably, a cling material is capable of being attracted to and/or adhering at least to glass or metal containers. If intended for use as a lidding material, the diffusion layer should be capable of sealing to other plastic materials. In such embodiments, a material can be selected to include a predetermined material property that performs the desired function. Preferably, the material is still permeable to both water vapor and active agent, to allow water vapor to activate the active agent, and to allow the active agent to enter the compartment of the package.

Cling materials can include a material selected from the group consisting of linear low density polyethylene, linear ultra low density polyethylene, polyethylene copolymer, ethylene-α-olefin copolymer, polyisobutylene, atactic polypropylene, cis-polybutadiene, bromobutyl rubber, ethylene vinyl acetate (EVA), ethyl methyl acetate (EMA), and combinations thereof. Selected cling materials are set forth in U.S. Pat. No. 4,624,991, U.S. Pat. No. 6,500,901, U.S. Pat. No. RE38,658, U.S. Pat. No. 4,348,455, U.S. Pat. No. 5,334,428, U.S. Pat. No. 6,083,611, and U.S. Pat. No. 4,430,457, each of which is incorporated herein in its entirety.

If the web material is embodied as a lidding material, the web material can include, but need not be limited to metal foils, polyethylene terephthalate, Nylon, metallized polymers, polyvinylidene chloride, and ethylene vinyl alcohol.

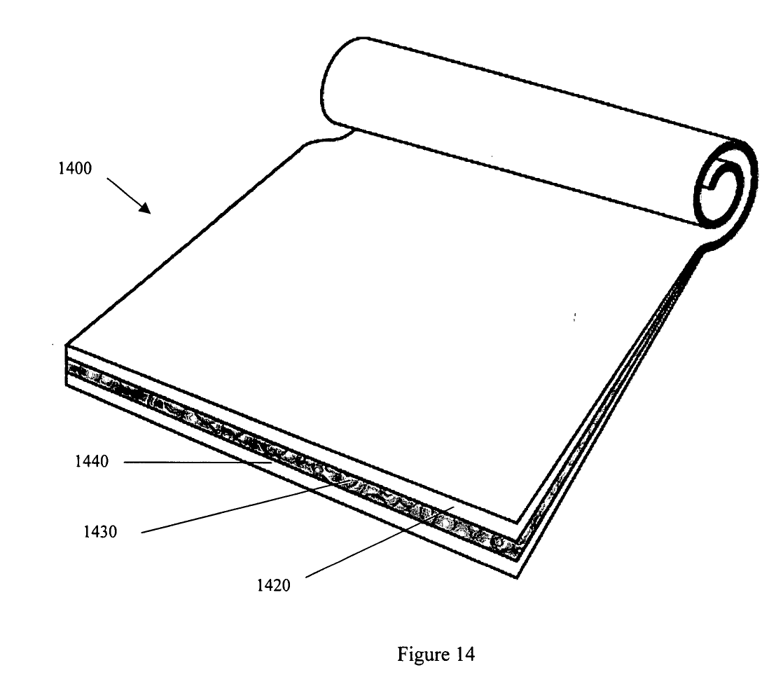

Further in accordance with the invention, a web material can include at least three material layers. FIG. 14 illustrates a web material 1400 similar to the web material 1300 of FIG. 13, but one which includes three such material layers. The web material includes a first material layer 1440, which is preferably a barrier layer, a second material layer 1430, which is preferably an active agent layer, and a third material layer 1420, which is preferably a functional layer 1420. At least one of either the active agent layer 1430 or the functional layer preferably acts as a diffusion layer, allowing passage of water and active agent vapor. The functional layer 1420 has a predetermined material property, such as providing cling and/or sealing characteristics, but also should be permeable to active agent vapor. Accordingly, a material for the functional layer 1420 that both provides the predetermined material property and is suitable for use as a diffusion layer for active agent vapor and water vapor, is desirable. Advantageously, the amount of functional layer can be reduced as compared with that incorporated with the embodiment of FIG. 13.

In the embodiments of FIGS. 13 and 14, the plurality of layers can be co-extruded during manufacture, or can be mutually attached following extrusion. Mutual attachment can be achieved in any suitable manner and can include spraying, dipping, static adhesion, printing, co-extrusion, electroless deposition, casting, vapor deposition, fusion, and/or embedding, among other processes. Further, the layers can be coextensive, or certain layers can extend further than other layers. Other variations and modifications are described in further detail. The amount and rate of active agent released from the web material can be controlled by adjusting the concentration of active agent and/or the diffusing characteristics of the diffusion layer.

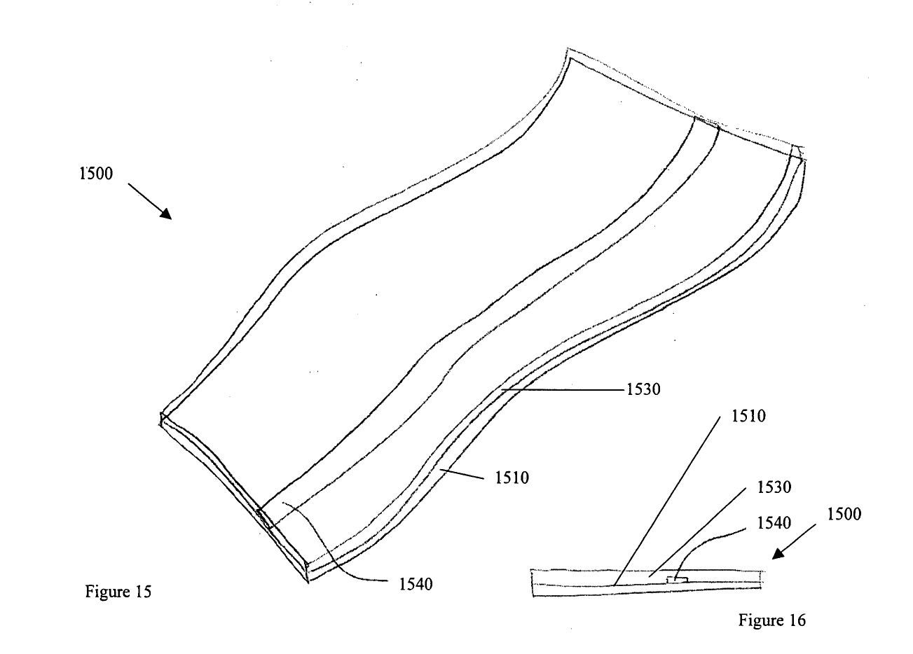

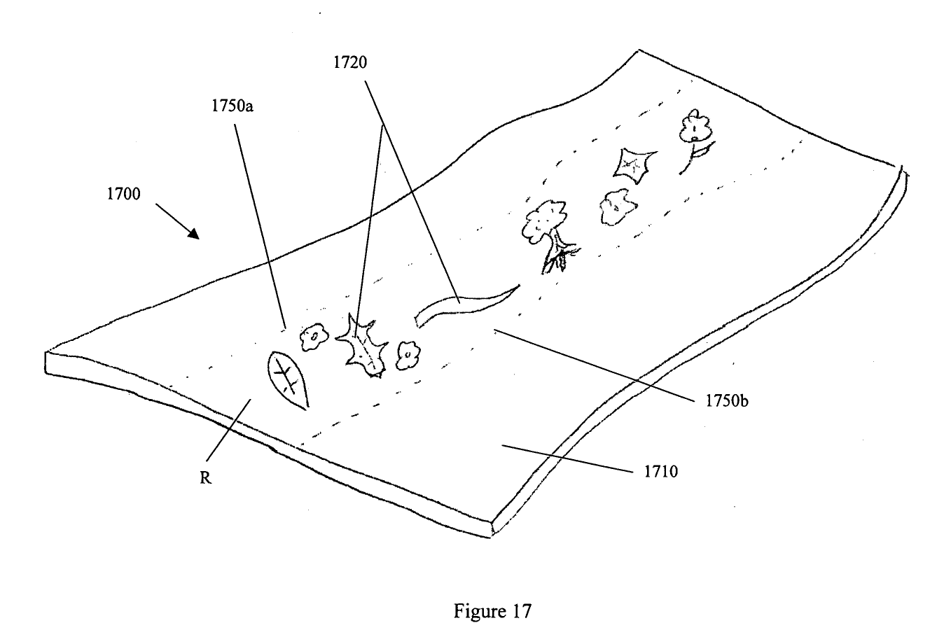

In accordance with another aspect, the invention includes a web material disposed in the form of a stripe on the first material layer. FIGS. 15 and 16 illustrate isometric and end views, respectively, of a web material 1500, wherein a first layer 1510 and a second layer 1530 are provided, and wherein \active agent is disposed in the form of a stripe 1540. The stripe can be incorporated in one of the first and second layers, or disposed between the first and second layers as depicted in FIG. 16. As set forth above, at least one of the first layer 1510 and the second layer 1530 embodied herein is a barrier layer, the other being a diffusion layer, permeable to at least active agent vapor. As set forth hereinabove, water vapor can act to initiate the release of active agent; therefore, the diffusion layer is also preferably permeable to water vapor. The width of the stripe 1540 therefore can be preselected so as to provide the desired amount of active agent at a desired location. The width of the stripe can range from a thin line to a layer that extends substantially across the entire with of the web material. As such, a range of amounts of active agent can be incorporated, thereby tailoring the amount of active agent released from the web material. If more active agent is desired, for example, then a wider stripe 1540 can be applied. If less is desired, a narrower stripe 1540 can be provided. Likewise, the location of active agent can be controlled by the location of the stripe. The relative amount of coverage provided by the stripe 1540 is referred to herein as the “active agent area.” As evident in the descriptions that follow, the active agent area is not limited to a straight line or stripe, but can include alternative configurations, including a pattern for the application of active agent in accordance with the invention. In a pattern, the active agent need not cover the entire region to which it is applied, and therefore, allows further tailoring of the available active agent, as appropriate.

FIG. 17 illustrates a web material 1700 in accordance with the invention, wherein active agent is disposed in a pattern 1720 on a material web 1710. The material web can be any suitable material, but preferably includes a barrier material. Additionally, the material web 1710 can include at least one predetermined material property to provide features such as cling or sealing capability. In the embodiment illustrated, the pattern 1720 is confined by borders 1750a and 1750b, which define an active agent region R. In this embodiment, active agent is only applied as part of the pattern. As is apparent from the figure, the active agent area can be reduced when the active agent is disposed in a pattern. The active agent can be applied in any of an endless variety of patterns by way of, e.g. printing plates, roller(s), brush(es), or ink jet. In certain embodiments, the active agent is disposed in conjunction with color indicators. Such indicators can also be applied in a pattern together with or separate from the active agent. Further, the pattern and/or any other mode of presenting the active agent, can include colorants to provide a desired aesthetic effect. Accordingly, if desired, color images can be provided, with such images also carrying active agent.

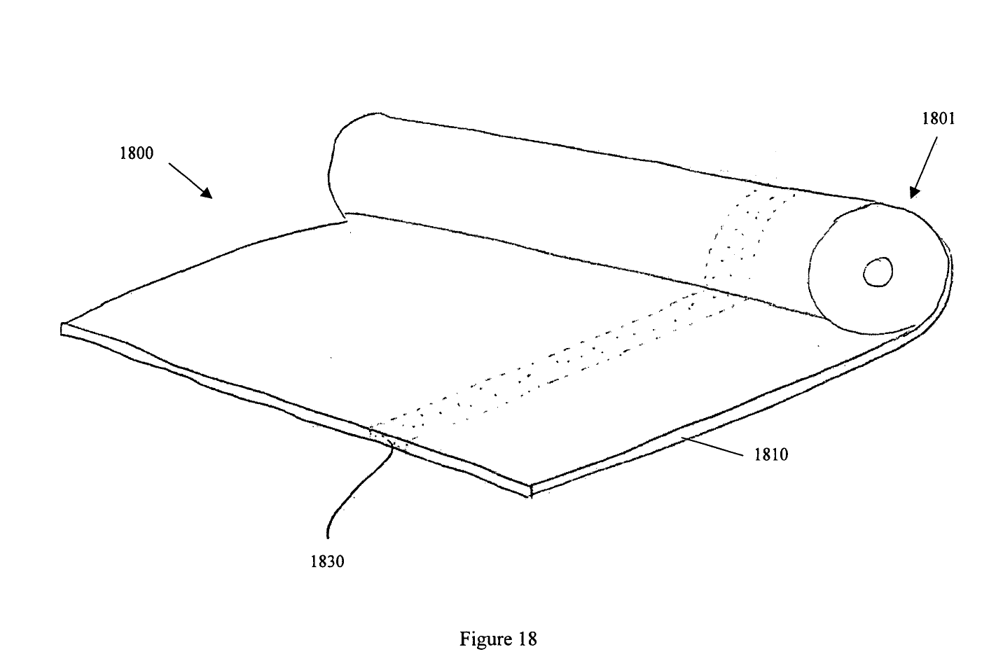

As an alternative to the embodiment of FIG. 15, FIG. 18 illustrates a web material 1800, in accordance with the invention in which active agent 1830 is carried by the first material layer 1810 of the web material 1800, which itself is provided in a roll 1801. In accordance with the invention, the web material includes a first layer, which is preferably a barrier material, and an active agent carried by the first material layer. As embodied herein, and as depicted in FIG. 18, the active agent is preferably disposed in the form of a stripe. Alternatively, the active agent can be incorporated into the web material. In this embodiment, it is desirable to use a material for the first material layer 1810 that is permeable to the active agent, so that once activated, the active agent vapor can be released from the web material 1800. Accordingly, materials suitable for use as diffusion materials are preferred, at least for the portion of the web material 1800 that contains active agent 1830. To inhibit the activation and release of active agent into the surrounding environment, the embodiment of FIG. 18 can be paired with a barrier material. The barrier material can be laminated or co-extruded with the first material layer 1810 to form a further web material, for example, a wrap material or lid stock, depending on the materials selected.

The first material layer 1810 can be extruded with the active agent 1830 illustrated, in one co-extrusion step. A modular die can be used for this purpose, such as those found, for example, in U.S. Pat. Nos. 5,762,971, 6,413,595 and 6,000,926. The active agent can be premixed with the material used for the first material layer 1810, in the region of the die designated for extrusion of the active agent strip 1830 or simply injected into that portion of the extrusion die. Further, the web material 1800 can be provided with a removable release liner, as described below, such as waxed paper, to prevent premature release of active agent therefrom, prior to use. Once drawn from the roll 1801, such removable release liner may be removed to allow active agent to be released. Accordingly, a release liner having sufficient barrier properties is preferred.

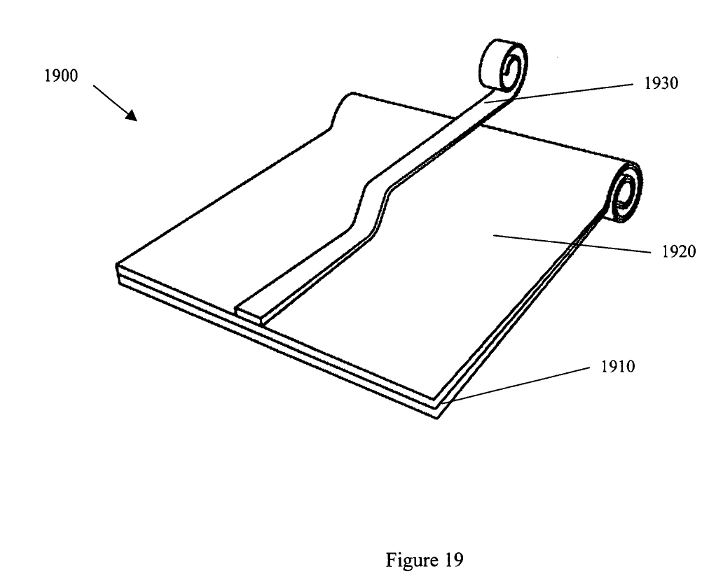

In accordance with another aspect of the invention, FIG. 19 illustrates a web material 1900 wherein a stripe of active agent material in the form of a tape 1930 is applied to a surface of a base material web 1920. The web material 1900 can then be processed by any number of subsequent steps or techniques. The web material 1900 can be formed into a package, such as a bag, heat sealing edges and attaching reclosable fasteners, if desired. Alternatively, the web material can be prepared further by incorporating additional material layers, such as a material layer with predetermined material properties, including permeability, cling or sealing characteristics. Alternatively or additionally, a removable cover or covers can be applied for selective activation of the active agent.

The material web 1920 can have a plurality of layers joined along an interface, such as interface 1910, although a single layer can be used if desired. The materials for the web material 1900 preferably include at least one barrier layer. Further, the tape preferably includes properties of a diffusion layer to allow passage of active agent therefrom. The tape 1930, which contains active agent, can be applied via an adhesive, heat seal, sonic weld or other attachment technique, such as those set forth herein. Alternatively, the tape 1930 can be extruded concurrently with the material web 1920, and joined thereto during or after forming.

The web materials having active agents, e.g. freshness extension structures incorporated therewith of the present invention, if disposed as a patch, tape, or pouch, can be attached to a package such as a reclosable bag by a pressure-sensitive self-adhesive. The pressure-sensitive self-adhesive can be any suitable adhesive that affixes the freshness-extension structure to the reclosable package. Non-limiting examples of suitable pressure-sensitive adhesives include acrylic or rubber-based adhesives. While a pouch of antimicrobial agent can be utilized in certain embodiments, relatively flat web materials are preferred.

When provided in the form of a tape or patch, the freshness-extension structure can be roll fed onto a layer(s) of the web material, as shown in FIG. 19. The roll-fed freshness-extension structure can initially include a release liner to assist in proper placement of the freshness-extension structure. The release liner, if used, is separated from the roll-fed freshness-extension structure before the tape or patch is attached to the reclosable web material. Examples of release liners include silicon-coated paper. Alternatively, the freshness-extension structure can be roll fed without the use of a release liner before being attached to the web material, if desired. Furthermore, the freshness-extension structure can be magazine fed during attachment to the reclosable package.

According to another embodiment, the freshness-extension structure patch, tape, or pouch can be heat sealed or welded directly to the web material. For example, the freshness extension structure can be roll fed or magazine fed before being heat sealed or welded to the reclosable package. In a heat-sealing embodiment, a release liner would not be needed. The freshness-extension structure can be attached continually to the web material, or at selected locations, if desired. Alternatively, the freshness-extension structure can be attached to the body panels during the formation of the package. For example, the freshness-extension structure can extend between the side seals formed between the first and second body panels so as to be secured by the side seals. It is contemplated that other attaching methods can be used.

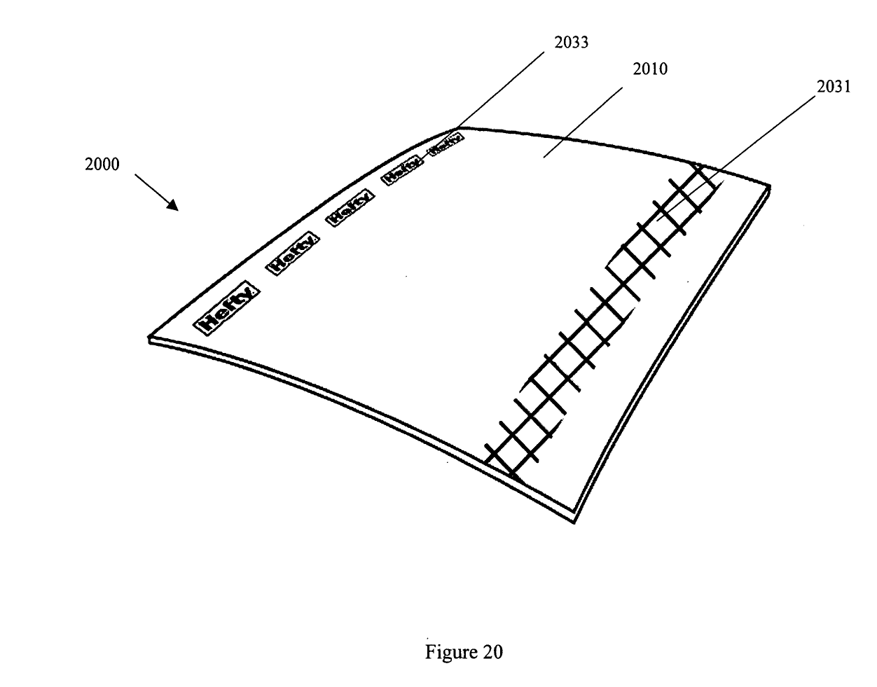

FIG. 20 is an isometric view of another embodiment of a web material 2000 in accordance with another aspect of the invention, including active agent applied in a pattern 2031, 2033 to a base layer. The pattern 2032, 2033 can be applied to the base material web 2010 by any suitable mode, such as those set forth herein. For example, a repetitive printed pattern, such as the logo 2033 or cross-hatch 2031 can be printed by way of plates, while a pattern such as an expiration date, brand name, product contents or other changeable text, can be printed by way of an ink-jet. If desired, active agent can be disposed in the form of printed text. Moreover, a color indicator, such as those described herein, can be utilized—further enhancing the functionality of a package. As with other web materials described herein, the web material 2000 can be used to form any of a variety of items, including wraps, lid stock and bags. In accordance with the invention, any suitable material, such as those set forth above, can be used to form the web material 2000. Preferably, the material web 2010 of the web material 2000, on which the active agent is applied, is a barrier material so that the active agent is not released inadvertently or leaked through a wall of a package.

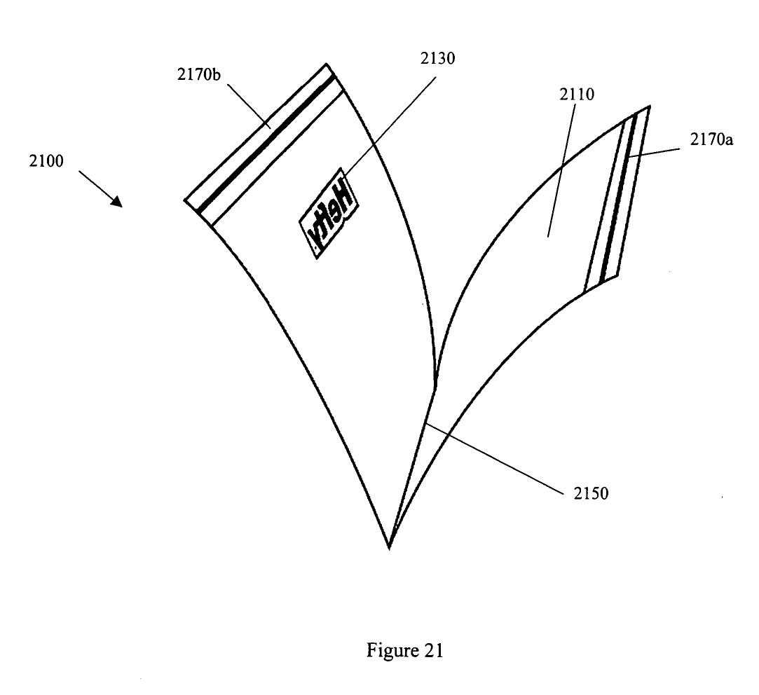

FIG. 21 is an isometric view of another embodiment of a web material in accordance with the invention, illustrating a partially exploded view of a reclosable bag 2100 formed from the web material 2110. As shown, a logo 2130 is disposed on a body panel of the bag 2100. The bag 2100 can be made from one web material 2110, folded along a crease 2150, or can be formed from a plurality of distinct web materials, such as a first web material having an active agent, and a second web material with or without active agent. As with the embodiment of FIG. 20, the logo 2130 can include active agent therein, and can be applied to the web material 2110 by way of printing, for example. Alternatively, the logo 2130 can be disposed on a patch, in any of the embodiments described above, with the patch attached to the web material 2110 prior to forming the web material 2110 into the reclosable bag 2100. Preferably, such patches are applied to the web material 2110 at regular intervals which allows the patches ultimately to be disposed in individual bags or packages once the packages are formed from the web material 2110. Further, reclosable fastener portions 2170a, 2170b are applied to the web material 2110, if desired, and the body panels made of the web material 2110 are sealed and thereby formed into the final bag.

The reclosable packages, such as reclosable bag 2100 or reclosable package 10 (FIG. 1), can be formed of any suitable material, such as by a thermoplastic material suitable for storing or collecting items, including perishables storage. Examples include common-sized reclosable packages such as pint storage and freezer bags, quart storage and freezer bags, and gallon storage and freezer bags. The reclosable packages are typically formed from polymeric materials such as polyolefinic materials. Non-limiting examples of polyolefinic materials include polyethylenes, polypropylenes, polystyrene, and combinations thereof For example, some types of polyethylenes materials include high density polyethylenes (HDPE), low density polyethylenes (LDPE), linear low density polyethylenes (LLDPE), and combinations thereof. It is also contemplated that materials such as plastomers, elastomers, ethylene vinyl acetates (EVA), ethyl methacrylates, polymethylpentene copolymers, polyisbutylenes, polyolefin ionomers, cyclic olefin copolymers (COCs) or combinations thereof, including polyethylenes, and/or polypropylenes may be used in forming the reclosable packages of the present invention. The thicknesses of the reclosable packages can vary in the present invention, but are generally from about 0.5 mil to about 5 mils and, more specifically, from about 1 mil to about 3 mils.

As previously described herein, the freshness-extension agents of the present invention can be used in combination with a web material for use in forming a body panel of a package. Alternatively and/or in combination, the freshness-extension agents of the present invention can be used in combination with fin portions of a fastener of a reclosable package, as further described in co-pending U.S. patent application Ser. No. 11/055,574, the contents of which application are expressly incorporated by reference herein in its entirety.

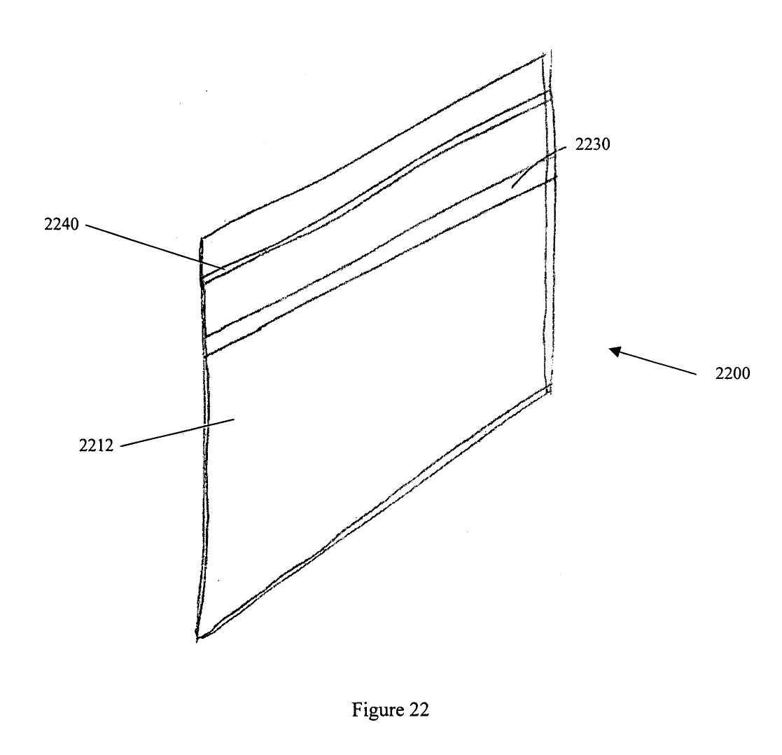

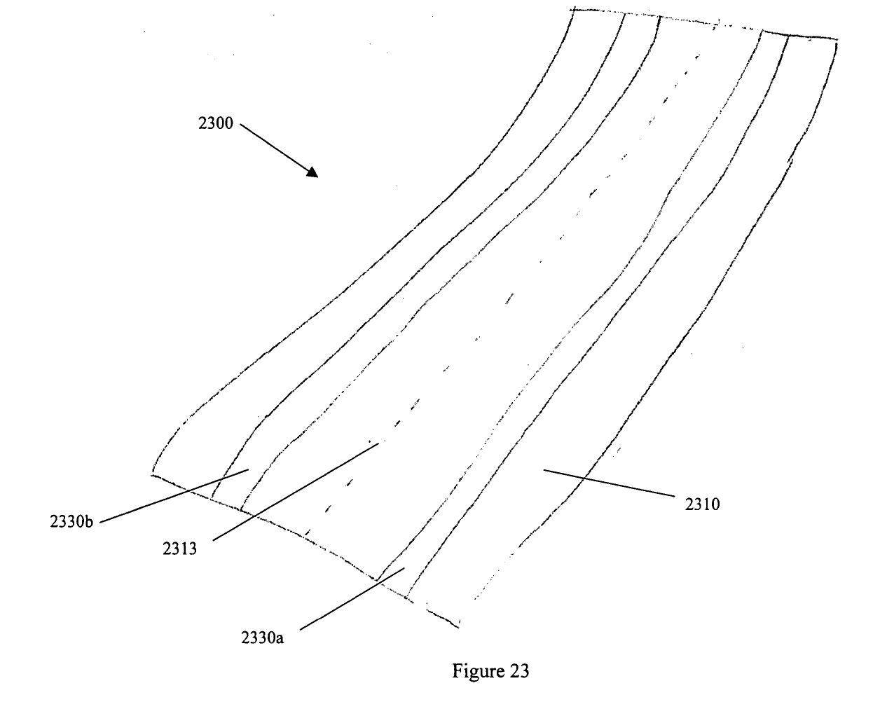

FIG. 22 is an isometric view of preferred embodiment of a web material in accordance with the invention, wherein the web material 2212 with a stripe 2230 of active agent has been formed into a reclosable bag 2200. The web material can include any of the features and materials of construction described herein. As embodied, a reclosable fastener 2240 is provided, and the stripe 2230 extends the entire width of the bag 2200, preferably proximate the mouth of the bag. The web material 2212 used for forming this bag 2200 can include any of those set forth herein, such as web materials 1500, 1700, 1800, 1900, 2000 and 2300, for example.

FIG. 23 is an isometric view of another embodiment of a web material in accordance with the invention, wherein the web material 2300 includes a plurality of stripes 2330a, 2330b of active agent provided on a base material 2310. As with the embodiments of FIGS. 9a, 9b, 10a, 10b, 10c, 11b and 12b, the active agent can be provided in a plurality of portions. Stripes 2330a, 2330b generally are aligned together when the web material 2300 is folded along line 2313 during manufacture. Any of the features set forth herein can be applied to the web material 2300, particularly the features described in connection with FIGS. 9a, 9b, 10a, 10b, 10c, 11b and 12b.

Alternatively, the web material 2300 can be formed into a wrap or lidding material, and not folded along line 2313. When embodied as a wrap or lidding material, a functional layer (e.g., a sealable layer or cling layer) can be disposed adjacent the base material 2310 and stripes 2330a, 2330b. As with similar foregoing embodiments, the functional layer preferably is permeable to active agent vapor to allow release of the active agent from the web material. Alternatively, the base material and stripes 2330a, 2330b can provide such function, if constructed from appropriate materials.

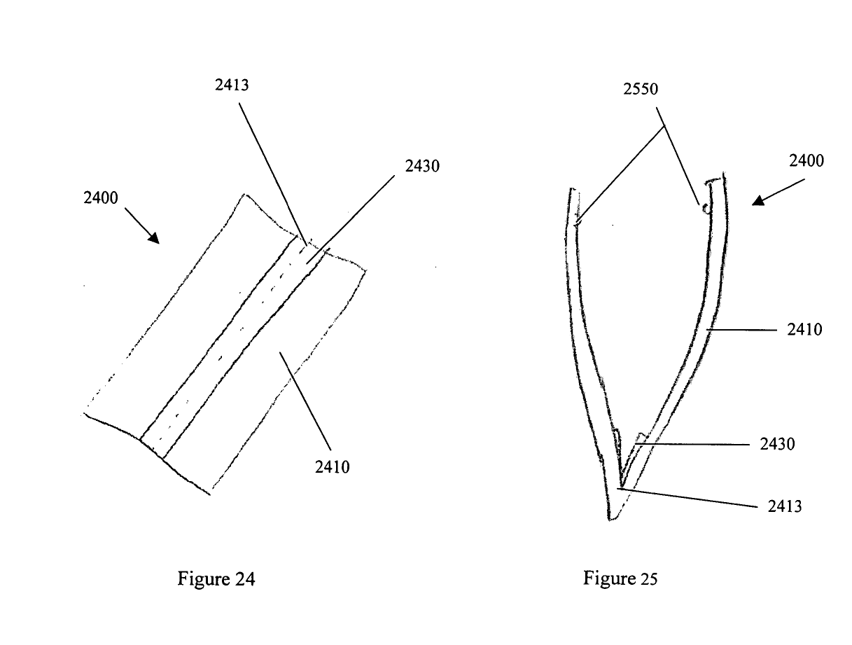

FIGS. 24 and 25 are isometric and end views of another embodiment of a web material in accordance with the invention, wherein the web material 2400 includes a centrally oriented stripe 2430 of active agent. As with the foregoing embodiment, the web material 2400 can be folded along a center line 2413. Both the active agent stripe 2430 and reclosable fastener 2550 can be attached to the base web material 2410 or formed integrally therewith. Alternatively, as with each embodiment herein, the active agent can be incorporated in the web material 2410. A bag formed by this embodiment of the web material 2400 can be used, for example, in situations where an inconspicuous placement of active agent at the bottom of the bag is desirable. Moreover, features set forth hereinabove in connection with other embodiments can be applied to this embodiment.

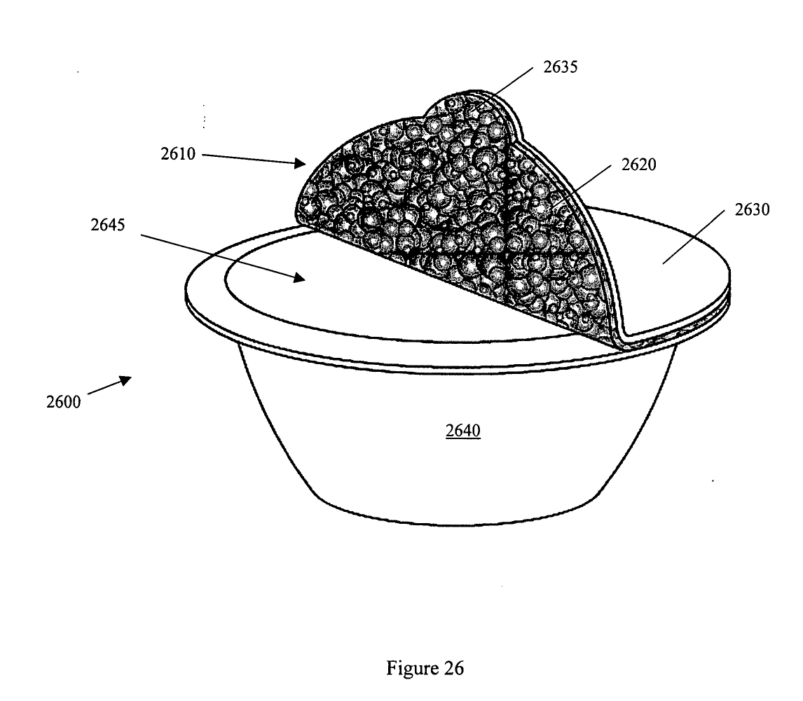

FIG. 26 is an isometric view of a container 2600, which incorporates another embodiment of a web material in accordance with the invention, wherein the web material 2610 is a lidding material for application to a base or receptacle 2640. As set forth above, for example as in connection with the embodiments of FIGS. 13 and 14, the lidding material can include two or more layers, wherein the layer most adjacent to the receptacle 2640 is capable of being sealed thereto. The lowermost layer 2620 preferably is permeable to active agent vapor to allow the release of active agent into receptacle space 2645 of the package. Suitable materials, as previously described, allow relatively easy removal from the receptacle 2640, when removal is desired. The outermost layer is preferably a barrier material selected from those set forth hereinabove.

While the disclosed web materials with active agent have been shown and described with reference to the illustrated embodiments, those of ordinary skill in the art will recognize and/or be able to ascertain many equivalents to those embodiments. Such equivalents are encompassed by the scope of the present disclosure and the appended claims.

For example, those of ordinary skill in the art will understand that the present invention has applications to various types of packages and containers, including non-reclosable bags and liners, rigid containers such as plastic containers, lunch containers, rigid trash containers, perishable packaging wraps and foils, such as food wraps and agricultural and/or industrial wraps and lidding materials or the like. Similarly, those of ordinary skill in the art will understand that the present invention has applications to active agents other than freshness-extension agents, such as odor management agents and other agents providing a desired function or effect on a package or the contents disposed therein.

Unless otherwise provided, when the articles “a” or “an” are used herein to modify a noun, they can be understood to include one or more than one of the modified noun.

What is claimed is:

1. A web material comprising:
a first material layer made of a barrier material; and
an active agent carried by the first material layer.

2. The web material of claim 1, wherein the barrier material is a lidding material selected from the group consisting of metal foil, polyethylene terephthalate, Nylon, metallized polymers, polyvinylidene chloride, and ethylene vinyl alcohol.

3. The web material of claim 1, wherein the barrier material is a wrap material made from a polymer selected from the group consisting of polyvinylidene chloride, polyvinyl chloride, polyethylene, ethylmethyl acrylate and polyisobutylene.

4. The web material of claim 1, wherein the barrier material is capable of inhibiting transfer of water therethrough.

5. The web material of claim 1, wherein the barrier material is capable of inhibiting transfer of the active agent therethrough.

6. The web material of claim 1, wherein the active agent is disposed in the form of a coating on the first material layer.

7. The web material of claim 1, wherein the active agent is disposed in the form of a stripe on the first material layer.

8. The web material of claim 1, wherein the active agent is disposed in the form of a pattern distributed on the first material layer.

9. The web material of claim 1, wherein the active agent is disposed in microcapsules.

10. The web material of claim 1, wherein the active agent is disposed through co-extrusion with the barrier material of the first material layer.

11. The web material of claim 1, wherein the active agent is selected from the group consisting of a freshness-extension agent, an antimicrobial agent, an odor management agent, a color indicator, a spoilage indicator, a fragrant, and combinations thereof.

12. The web material of claim 1, further comprising a second material layer having a predetermined material property.

13. The web material of claim 12, wherein the predetermined material property includes cling characteristics.

14. The web material of claim 12, wherein the predetermined material property includes a sealing characteristic.

15. The web material of claim 14, wherein the sealing characteristic includes at least one of a heat seal, cold seal, ultrasonic, friction characteristic, adhesive or cohesive.

16. The web material of claim 12, wherein the predetermined material property includes permeability to the active agent.

17. The web material of claim 12, wherein the predetermined material property includes permeability to water.

18. The web material of claim 12, wherein the second material layer is hydrophilic.

19. The web material of claim 12, wherein the active agent is disposed in an intermediate layer between the first material layer and the second material layer.

20. The web material of claim 12, further comprising at least one additional layer disposed between the active agent and the first material layer.

21. The web material of claim 12, wherein the second material layer is made of a barrier material, the second material layer being removable from the first material layer.

22. The web material of claim 1, wherein the web material is disposed in a roll.

23. The web material of claim 1, wherein the barrier material is a lidding material selected from the group consisting of metal foil, polyethylene terephthalate, Nylon, metallized polymers, polyvinylidene chloride, and ethylene vinyl alcohol.

24. The web material of claim 1, wherein the active agent is activated by water.

25. A web material comprising:
a first material layer made of a barrier material;
an active agent carried by the first material layer; and
a second material layer disposed adjacent the first material layer, the second material layer having a predetermined material property.
